(19) United States
(12) Patent Application Publication
(10) Pub. No.: US 2017/0190069 A1
(43) Pub. Date: Jul. 6, 2017

(54) CUTTING DATA CREATION METHOD, CUTTING DATA CREATION DEVICE, AND COMPUTER-READABLE RECORDING MEDIUM

(71) Applicant: BROTHER KOGYO KABUSHIKI KAISHA, Nagoya (JP)

(72) Inventor: Satomi Yamamoto, Nagoya (JP)

(21) Appl. No.: 15/467,653

(22) Filed: Mar. 23, 2017

Related U.S. Application Data
(63) Continuation of application No. PCT/JP2015/085635, filed on Dec. 21, 2015.

(30) Foreign Application Priority Data
Dec. 25, 2014 (JP) 2014-262360

(51) Int. Cl. B26D 5/00; G05B 19/4097; G05B 19/042; B26D 5/20; B44C 3/02

(52) U.S. Cl. CPC B26D 5/005; B26D 5/20; B44C 3/02; G05B 19/0426; G05B 19/4097; G05B 2219/45038

(57) ABSTRACT

A cutting data creation method, a cutting data creation device, and a computer-readable recording medium capable of creating desired decoration representing an entire pattern formed of a combination of partial patterns by superimposing sheets as an object to be cut. The cutting data creation device includes a discrimination unit, an order decision unit, an outline setting unit, and a cutting data creation unit. The discrimination unit discriminates whether or not a partial patterns is included in another partial patterns. The order decision unit decides an overlapping order of the partial patterns corresponding to an overlapping order of the sheets based on a result of the discrimination as to the inclusion of the partial patterns. The outline setting unit sets an outline of each of the partial patterns to layers. The cutting data creation unit creates cutting data based on the outline of each partial pattern set for each layer.

### CROSS-REFERENCE TO RELATED APPLICATIONS

This application is a continuation application of International Application No. PCT/JP2015/085635, filed on Dec. 21, 2015, which claims priority from Japanese Patent Application No. 2014-262360, filed on Dec. 25, 2014. The disclosure of the foregoing application is hereby incorporated by reference in its entirety.

### FIELD

The disclosure relates to a cutting data creation method, a cutting data creation device, and a computer-readable recording medium for creating cutting data for cutting sheets to prepare a decoration formed by superimposing a plurality of sheets.

### BACKGROUND

A cutting apparatus for automatically cutting a sheet, such as paper, as an object to be cut has been conventionally known.

For example, a cutting apparatus disclosed in Japanese Patent Laid-Open No. 2012-206237 includes a display. A user selects a desired pattern from among a plurality of patterns displayed on the display. The sheet is attached to a holding member having an adhesive layer formed on the surface thereof. The cutting apparatus performs an operation in which both end parts of the holding member are sandwiched between a drive roller and a pinch roller of a drive mechanism in the vertical direction and are moved in a first direction and a carriage including a cutter is moved in a second direction orthogonal to the first direction. This operation allows the sheet to be cut along the outline of the selected pattern.

In order to prepare a decoration formed by superimposing a plurality of sheets, partial patterns cut out from other sheets are first attached in an overlapping manner to a base sheet. Then, partial patterns which have different shapes and are cut out from other sheets are attached in an overlapping manner. Thus, the decoration representing an entire pattern which is formed of a combination of a plurality of partial patterns and has a convex shape or a concave shape can be prepared.

However, the cutting apparatus of the related art can cut out a desired pattern from one sheet, but cannot prepare a decoration in the manner as described above. Accordingly, in order to prepare the decoration, the user is required to manually cut out partial patterns from sheets using, for example, scissors, instead of using the cutting apparatus. Specifically, the user has no choice but to prepare the decoration while imaging the entire pattern and determining the shape, size, and layout of each partial pattern to be cut out from the sheets.

### SUMMARY

The disclosure has been made in view of the above-mentioned circumstances, and an object of the disclosure is to provide a cutting data creation method, a cutting data creation device, and a computer-readable recording medium which are capable of easily preparing a desired decoration representing an entire pattern of a combination of partial patterns by superimposing a plurality of sheets as an object to be cut.

In order to attain the above-mentioned object, a first exemplary aspect of the disclosure is a cutting data creation method for creating cutting data for preparing a decoration representing an entire pattern formed of a combination of a plurality of partial patterns by superimposing a plurality of sheets cut along an outline of each of the plurality of partial patterns, the cutting data creation method including: a discrimination step of discriminating, for each partial pattern, whether or not one of the plurality of partial patterns is included in another one of the plurality of partial patterns; an order decision step of deciding an overlapping order of the plurality of partial patterns corresponding to an overlapping order of the plurality of sheets based on a result of the discrimination as to whether or not one of the plurality of partial patterns is included in another one of the plurality of partial patterns in the discrimination step; an outline setting step of setting an outline of each of the partial patterns for each of the sheets corresponding to the order decided in the order decision step; and a cutting data creation step of creating cutting data based on the outline of each of the partial patterns set for each of the sheets in the outline setting step.

A second exemplary aspect of the disclosure is a cutting data creation device for creating cutting data for preparing a decoration representing an entire pattern formed of a combination of a plurality of partial patterns by superimposing a plurality of sheets cut along an outline of each of the plurality of partial patterns, the cutting data creation device including: a discrimination unit configured to discriminate, for each partial pattern, whether or not one of the plurality of partial patterns is included in another one of the plurality of partial patterns; an order decision unit configured to decide an overlapping order of the plurality of partial patterns corresponding to an overlapping order of the plurality of sheets based on a result of the discrimination as to whether or not one of the plurality of partial patterns is included in another one of the plurality of partial patterns by the discrimination unit; an outline setting unit configured to set, for each layer corresponding to the order decided by the order decision unit, an outline of each of the partial patterns to a plurality of layers respectively corresponding to the plurality of sheets; and a cutting data creation unit configured to create cutting data corresponding to the plurality of sheets based on the outline of each of the partial patterns set for each of the layers by the outline setting unit.

A third exemplary aspect of the disclosure is a computer-readable recording medium recording a program for causing a computer to function as various processing units of the cutting data creation device according to the above-mentioned exemplary aspect.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is an overall perspective view illustrating a cutting data creation device and a cutting device that are connected to each other according to a first exemplary embodiment;

FIG. 2 is a block diagram showing an electrical configuration;

FIG. 3A is a front view showing a decoration representing an entire pattern;

FIG. 3B is an explanatory diagram showing a plurality of sheets cut in a first mode;

FIG. 3C is an explanatory diagram showing a plurality of sheets cut in a second mode;

FIG. 4A is an enlarged explanatory diagram showing cutting-plane lines for partial patterns C to E;

FIG. 4B is an explanatory diagram showing a cutting-plane line for another partial pattern (No. 1);

FIG. 4C is an explanatory diagram showing a cutting-plane line for still another partial pattern (No. 2);

FIG. 4D is an explanatory diagram showing a cutting-plane line for still one more partial pattern (No. 3);

FIG. 5A is an explanatory diagram showing a structure of first cutting data;

FIG. 5B is an explanatory diagram showing a structure of second cutting data;

FIG. 6 is a diagram showing layers and a process of generating the first cutting data in the first mode;

FIG. 7 is a diagram corresponding to FIG. 6 and showing a process of generating the second cutting data in the second mode;

FIG. 8 is a flowchart showing a flow of an overall process of a cutting data creation program;

FIG. 9 is a flowchart showing a cutting data creation process in the first mode;

FIG. 10 is a flowchart showing a partial pattern inclusion information acquisition process;

FIG. 11 is a flowchart showing a partial pattern grouping process (No. 1);

FIG. 12 is a flowchart showing a partial pattern grouping process (No. 2);

FIG. 13 is a flowchart showing an overlapping order decision process in the first mode;

FIG. 14 is a flowchart showing a cutting data creation process in the second mode;

FIG. 15 is a flowchart showing an overlapping order decision process in the second mode;

FIG. 16 is an explanatory diagram showing grouping of partial patterns by using an example of another entire pattern;

FIG. 17 is an explanatory diagram showing a grouping process based on the set number of sheets and color information according to a second exemplary embodiment;

FIG. 18 is a diagram corresponding to FIG. 8 and showing the second exemplary embodiment; and

FIG. 19 is a flowchart showing a grouping process according to the second exemplary embodiment.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

### First Exemplary Embodiment

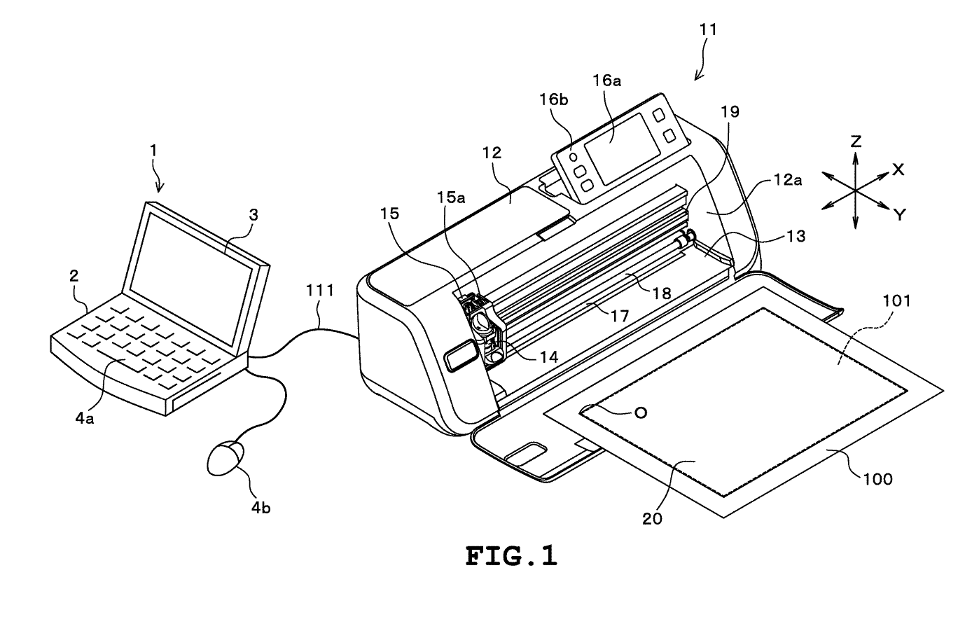

A first exemplary embodiment of the present disclosure will be described below with reference to the drawings. FIG. 1 shows a cutting data creation device 1 and a cutting device 11. The cutting data creation device 1 and the cutting device 11 are connected to each other through a communication cable 111.

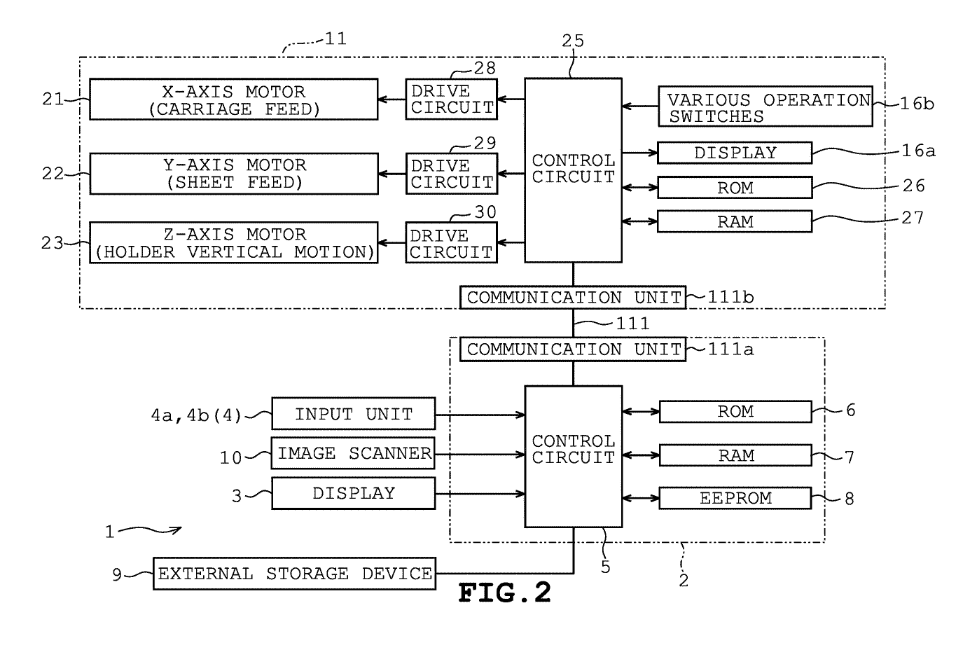

The cutting data creation device 1 is composed of, for example, a general-purpose personal computer (PC). Specifically, the cutting data creation device 1 includes a creation device body unit 2, which is composed of a personal computer body, a display unit (hereinafter referred to as a display 3), which is composed of, for example, a color liquid crystal display, and an input unit 4 including a keyboard 4a and a mouse 4b. The cutting data creation device 1 also includes an image scanner 10 (shown only in FIG. 2) which is capable of reading color images.

As shown in FIG. 2, a control circuit 5 of the creation device body unit 2 is mainly composed of a computer (CPU), and is connected to a ROM 6, a RAM 7, and an EEPROM 8. The control circuit 5 is connected to each of the input unit 4 including the keyboard 4a and the mouse 4b, the display 3, the image scanner 10, and an external storage device 9 which is detachably attached to the creation device body unit 2. An internal storage device in the EEPROM 8 or the external storage device 9 stores a cutting data creation program to be described later. During execution of the cutting data creation program, various patterns and necessary information are displayed on the display 3. At this time, a user operates the keyboard 4a and the mouse 4b to perform a necessary input operation or an instruction, thereby allowing the cutting data creation device 1 to create cutting data.

The cutting data creation device 1 also includes a communication unit 111a. The communication unit 111a is connected to a communication unit 111b of the cutting device 11 through the communication cable 111. This configuration enables transmission and reception of data including the cutting data between the cutting data creation device 1 and the cutting device 11. The communication unit 111a of the cutting data creation device 1 and the communication unit 111b of the cutting device 11 may be connected wirelessly, instead of being connected with a wire.

The cutting device 11 cuts a sheet 20 as an object to be cut based on the cutting data. As shown in FIG. 1, the cutting device 11 includes a body cover 12 as a housing, a platen 13 disposed in the body cover 12, a carriage 15 having a cutter cartridge 14 mounted therein, and a holding member 100 for holding the sheet 20. The holding member 100 is formed into a rectangular flat-plate shape, and has an adhesive layer 101 (indicated by a dashed line in FIG. 1) formed on the surface thereof. The holding member 100 holds the sheet 20 attached to the adhesive layer 101, and is set so as to be placed on the platen 13 which is substantially horizontal.

The body cover 12 has a horizontally long, rectangular box shape. A front opening part 12a of the body cover 12 is set as a front side of the cutting device 11. Hereinafter, a front-back direction in which the holding member 100 is transferred on the platen 13 is referred to as a Y-direction, and a left-right direction orthogonal to the Y-direction is referred to as an X-direction. A vertical direction orthogonal to the platen 13 is referred to as a Z-direction.

At an upper right part of the body cover 12, a display 16a and various operation switches 16b are provided. The display 16a is composed of, for example, a color liquid crystal display, and displays necessary messages and the like for the user. The various operation switches 16b are used to perform an operation such as selection of first cutting data and second cutting data to be described later, and an instruction.

A machine casing in the body cover 12 is provided with a drive roller 17 and a pinch roller 18 that extend in the left-right direction. The drive roller 17 and the pinch roller 18 sandwich both end parts of the holding member 100 set on the platen 13 in the vertical direction. In the body cover 12, a Y-axis motor 22 (see FIG. 2) and a Y-axis movement mechanism (not shown) are provided. The Y-axis movement mechanism transmits a rotation motion of the Y-axis motor 22 to the drive roller 17, thereby allowing the holding member 100 to move with the sheet 20 in the Y-direction.

A machine casing in the body cover 12 is provided with an X-axis guide rail 19 for guiding the carriage 15 in the X-direction. In the body cover 12, an X-axis motor 21 (see FIG. 2) and an X-axis movement mechanism (not shown) are provided. The X-axis movement mechanism allows the carriage 15 to move in the X-direction along the X-axis guide rail 19 by the rotation of the X-axis motor 21.

At the front side of the carriage 15, a cartridge holder 15a is provided. The cutter cartridge 14 is detachably attached to the cartridge holder 15a. In the carriage 15, a Z-axis motor 23 (see FIG. 2) and a Z-axis movement mechanism (not shown) are provided. The Z-axis movement mechanism allows the cartridge holder 15a to move with the cutter cartridge 14 in the z-direction by the rotation of the Z-axis motor 23.

Although the detailed illustration is omitted, when the cartridge holder 15a is moved downward by the Z-axis movement mechanism, a blade edge of a cutter disposed at a lower end of the cutter cartridge 14 penetrates through the sheet 20 held by the holding member 100. In this state, the cutting device 11 moves the holding member 100 in the Y-direction through the Y-axis movement mechanism by a driving force of the Y-axis motor 22 and moves the carriage 15 in the X-direction through the X-axis movement mechanism by a driving force of the X-axis motor 21, thereby executing a cutting operation for the sheet 20. Thus, the X-axis movement mechanism, the Y-axis movement mechanism, and the Z-axis movement mechanism, and the motors 21, 22, and 23 corresponding to the X-axis movement mechanism, the Y-axis movement mechanism, and the Z-axis movement mechanism, respectively, function as relative movement units for allowing the cutter of the cutter cartridge 14 and the sheet 20 held by the holding member 100 to move relatively to each other. The relative movement units and the cutter cartridge 14 constitute a cutting unit.

In the cutting device 11, for example, an XY coordinate system in which a left corner part of the adhesive layer 101 in the holding member 100 shown in FIG. 1 is set as an origin O is set, and the holding member 100 and the cutter cartridge 14 move relatively to each other based on the XY coordinate system. In the cutting device 11, a pen cartridge (not shown) is prepared as a print unit, in addition to the cutter cartridge 14. Therefore, these cartridges are selectively attached to the cartridge holder 15a, thereby making it possible to execute a cutting operation or a print operation for the sheet 20. As for the detailed configuration of the cutting device 11, a configuration similar to that of Japanese Patent Laid-Open No. 2014-124748 filed by the applicant of the disclosure can be adopted, and thus the description thereof is omitted.

As shown in FIG. 2, a control circuit 25 of the cutting device 11 is mainly composed of a computer (CPU), and is connected to a ROM 26, an RAM 27, and the communication unit 111b. The ROM 26 stores a control program for controlling the cutting operation (or print operation) and the like. The control circuit 25 acquires the cutting data created by the cutting data creation device 1 through the communication unit 111b (communication cable 111).

The control circuit 25 is connected to each of the display 16a and the various operation switches 16b, and is also connected to drive circuits 28, 29, and 30 which drive the X-axis motor 21, the Y-axis motor 22, and the Z-axis motor 23, respectively. The control circuit 25 controls the X-axis motor 21, the Y-axis motor 22, the Z-axis motor 23, and the like based on the cutting data to automatically execute the cutting operation for the sheet 20 held by the holding member 100.

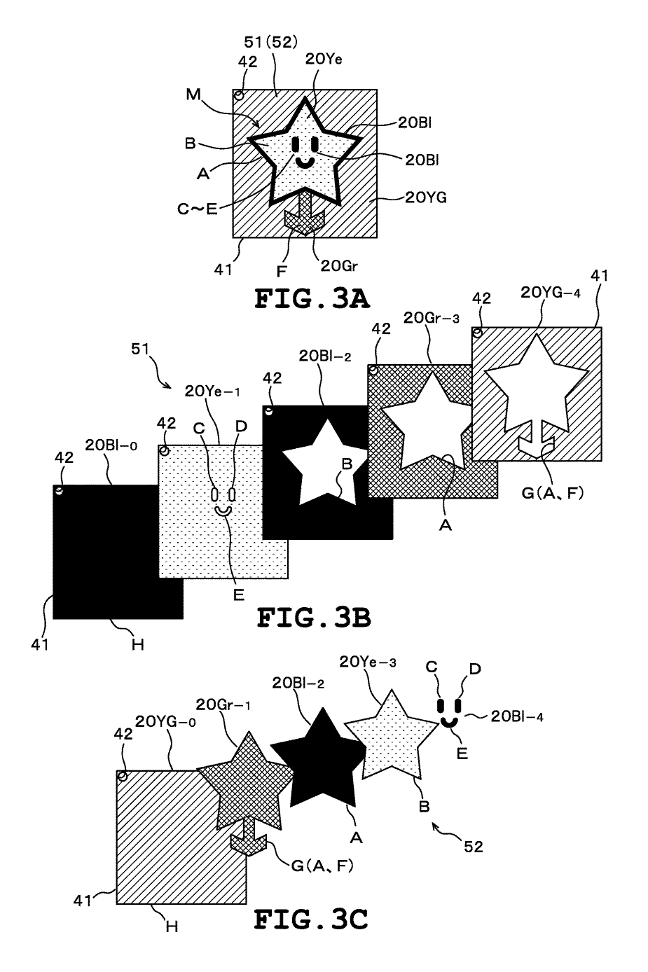

A decoration shown in FIG. 3A is prepared by superimposing a plurality of sheets 20 cut by the cutting device 11. This decoration includes a decoration 51 representing a pattern of “flower” with a concave shape, and a decoration 52 representing a pattern of “flower” with a convex shape. FIG. 3B shows a state in which the positions of the sheets 20 are shifted from each other so as to illustrate that the pattern of “flower” has a concave shape. FIG. 3C shows a state in which the positions of the sheets 20 are shifted from each other so as to illustrate that the pattern of “flower” has a convex shape.

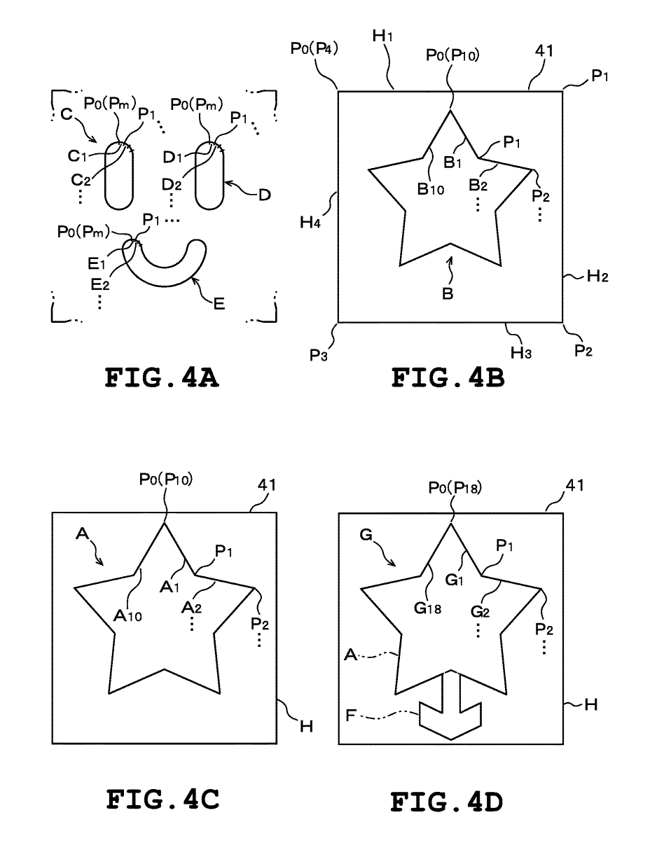

The pattern of “flower” represented by the decorations 51 and 52 is composed of patterns of “petals”, which form a star shape, “a left eye”, “a right eye”, “a mouth”, and “leaves and a stalk”. As shown in FIG. 3A, the pattern of “petals” is referred to as a second partial pattern B, and the pattern of larger petals formed along the outer edge of the petals is referred to as a first partial pattern A. The patterns of “a left eye”, “a right eye”, and “a mouth” are referred to as third, fourth, and fifth partial patterns C, D, and E, respectively. The pattern of “leaves and a stalk” is referred to as a sixth partial pattern F. A combined pattern of the first and sixth partial patterns A and F is referred to as a seventh partial pattern G (see FIG. 4D). A combined pattern of the first to seventh partial patterns A to G is referred to as an entire pattern M. A bottom sheet is referred to as a base sheet 20 (see a sheet 20B1-₀ shown in FIG. 3B and a sheet 20YG-₀ shown in FIG. 3C). The sheets 20 which are cut along the outline of any one of the first to seventh partial patterns A to G are superimposed on the base sheet 20. Thus, the pattern of “flower” shown in FIG. 3A is displayed as the entire pattern M formed of a combination of the first to seventh partial patterns A to G.

In the decoration 51 shown in FIG. 3B, a yellow sheet 20Ye obtained by cutting out the third to fifth partial patterns C to E, a black sheet 20B1 obtained by cutting out the second partial pattern B, a green sheet 20Gr obtained by cutting out the first partial pattern A, and a yellow-green sheet 20YG obtained by cutting out the seventh partial pattern G are sequentially superimposed on the black base sheet 20B1, thereby displaying the entire pattern M of “flower” with a concave shape.

In the decoration 52 shown in FIG. 3C, the green sheet 20Gr whose outer edge corresponds to the outline of the seventh partial pattern G, the black sheet 20B1 whose outer edge corresponds to the outline of the first partial pattern A, the yellow sheet 20Ye whose outer edge corresponds to the second partial pattern B, and the black sheet 20B1 whose outer edge corresponds to the outlines of the third to fifth partial patterns C to E are sequentially superimposed on the yellow-green base sheet 20YG, thereby displaying the entire pattern M of “flower” with a convex shape.

Hereinafter, in order to prepare the decoration 51 representing the entire pattern M with a concave shape, cutting data for cutting the sheets 20B1 to 20YG is referred to as first cutting data. On the other hand, in order to prepare the decoration 52 representing the entire pattern M with a convex shape, cutting data for cutting the sheets 20B1 to 20YG is referred to as second cutting data. In the decorations 51 and 52, sheets to be sequentially superimposed on the base sheet are referred to as first, second, third, and fourth sheets, respectively, so as to correspond to the overlapping order of the sheets. Note that reference symbols “Bl”, “Ye”, “Gr”, and “YG” which are assigned to the end of the sheets 20 in FIG. 3 and the like correspond to the colors of the sheets 20, and “Bl” represents black, “Ye” represents yellow, “Gr” represents green, and “YG” represents yellow-green. In FIG. 3 and the like, numbers “₋₀”, “₋₁”, . . . , and “₋₄” which are assigned to the end of the reference symbols “Bl to YG”, respectively, represent the base sheet, the first sheet, . . . , and the fourth sheet, respectively. For convenience of explanation, the first to seventh partial patterns A to G are hereinafter referred to simply as “partial pattern A” to “partial pattern G”, respectively.

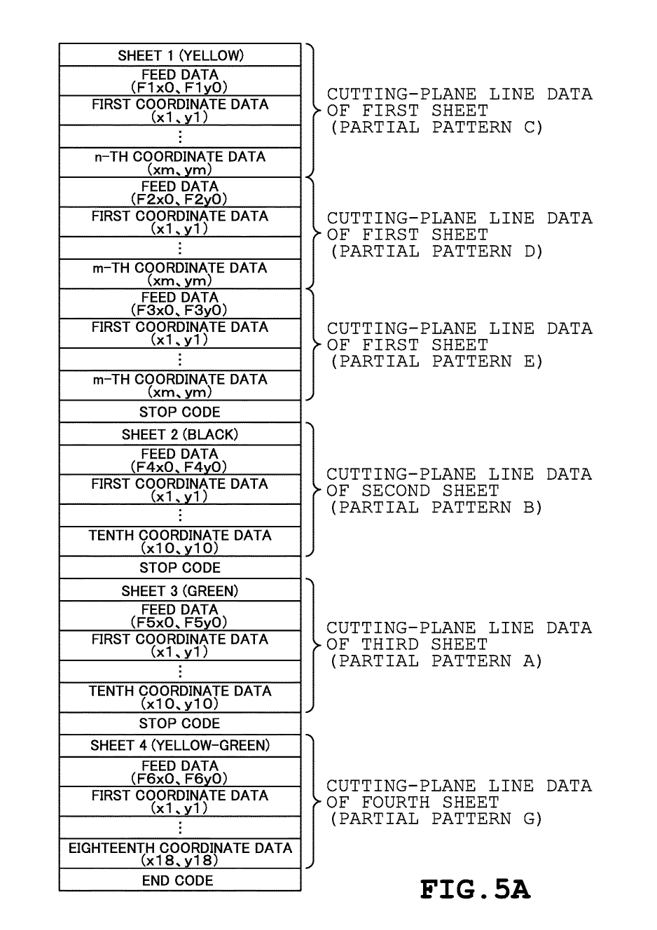

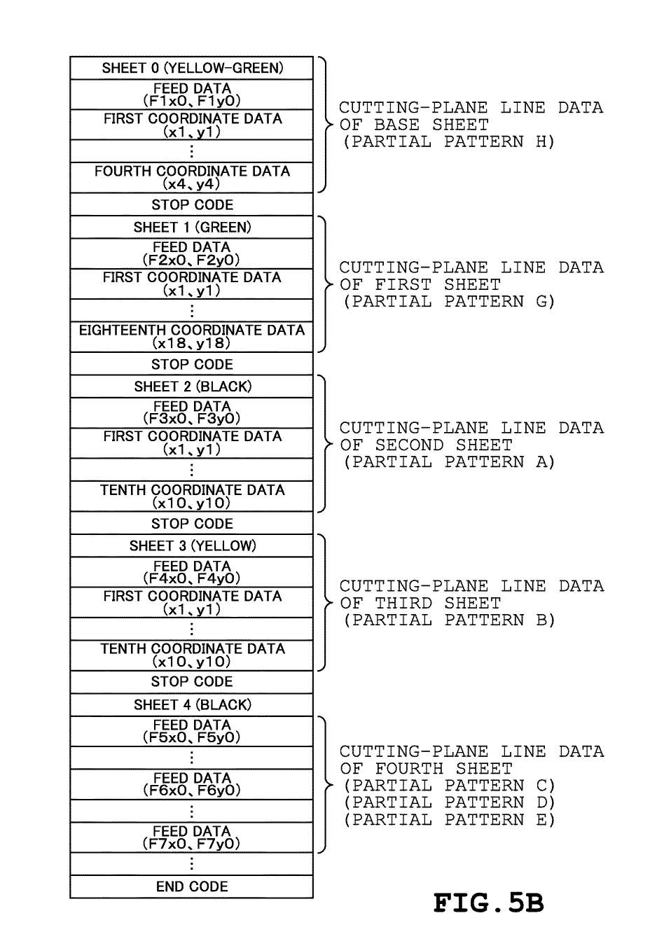

As shown in FIG. 5A, the first cutting data includes order data (sheets 1 to 4), feed data, coordinate data, a stop code, an end code, and data for display (not shown), for each of the partial pattern C of the first sheet 20Ye to the partial pattern G of the fourth sheet 20YG. Specifically, “sheet 1” to “sheet 4” shown in FIG. 5A represent order data indicating an overlapping order of the first sheet 20Ye to the fourth sheet 20YG. The color of each sheet is set to be linked to the order data so that data for specifying the sheets 20Ye to 20YG is represented by “yellow” and the like.

The coordinate data is defined by the XY coordinate system of the cutting device 11, and three sets of data, i.e., “first coordinate data (x1, y1) . . . m-th coordinate data (xm, ym)”, corresponding to order data “1” represent coordinate values for cutting the cutting-plane lines for the three partial patterns C to E. Reference symbol “m” assigned to the coordinate data represents the number of pieces of coordinate data set according to the shape of each of the partial patterns C to E. The coordinate data will be described with reference to the enlarged view of the partial patterns C to E shown in FIG. 4A.

The cutting-plane line for the partial pattern C of “a left eye” is composed of a plurality of line segments C₁, C₂, . . . , and Cₙ which constitute the outline of a substantially oval shape, and both ends of each line segment, i.e., a large number of points P₀, P₁, . . . and Pₙ, are set at a predetermined interval on an arc of the outline. The cutting-plane line data for the partial pattern C includes feed data (F1x0, F1y0), first coordinate data (x1, y1), . . . , and m-th coordinate data (xm, ym) respectively corresponding to the cutting start point P₀, the point P₁, . . . , and the cutting end point Pₙ. The feed data is data for moving the cutter of the cutting device 11 to the cutting start point P₀ when the cutting operation is started. Specifically, based on the feed data, the movement of the carriage 15 to the cutting start point P₀ during a feed operation including no cutting operation, and the vertical motion of the cutter are carried out.

Like the partial pattern C, the cutting-plane line for the partial pattern D of “a right eye” is composed of line segments D₁, D₂, . . . , and Dₙ which constitute the outline of a substantially oval shape, and the cutting-plane line data includes feed data (F2x0, F2y0), first coordinate data (x1, y1), . . . , and m-th coordinate data (xm, ym). The cutting-plane line for the partial pattern E of “a mouth” is composed of line segments E₁, E₂, . . . , and Eₙ which constitute the outline of a substantially oval curved shape, and the cutting-plane line data includes feed data (F3x0, F3y0), first coordinate data (x1, y1), . . . , and m-th coordinate data (xm, ym).

The cutting-plane line for the partial pattern B corresponding to order data “2” and the cutting-plane line for the partial pattern A with order data “3” form a similar a star shape (FIGS. 4B and 4C). The cutting-plane line for the partial pattern B is composed of ten line segments B₁, B₂, . . . , and Bio, and the cutting-plane line data for the partial pattern B includes feed data (F4x0, F4y0), first coordinate data (x1, y1), . . . , and tenth coordinate data (x10, y10) respectively corresponding to the cutting start point P₀, the point P₁, . . . , and the cutting end point P₁₀. The cutting-plane line for the partial pattern A is composed of ten line segments A₁, A₂, . . . , and A₁₀ which surround the cutting-plane line for the partial pattern B. The cutting-plane line data for the partial pattern A includes feed data (F5x0, F5y0), first coordinate data (x1, y1), . . . , and tenth coordinate data (x10, y10) respectively corresponding to the cutting start point P₀, the point P₁, . . . , and the cutting end point P₁₀.

The cutting-plane line for the partial pattern G corresponding to order data “4” is the outline of a combination of the adjacent partial patterns A and F. In other words, the cutting-plane line for the partial pattern G shown in FIG. 4D is composed of 18 line segments G₁, G₂, . . . , and G₁₈ which are obtained by connecting the outer edges of the two partial patterns A and F. The cutting-plane line data for the partial pattern G includes feed data (F6x0, F6y0), first coordinate data (x1, y1), . . . , and eighteenth coordinate data (x18, y18) respectively corresponding to the cutting start point P₀, the point P₁, . . . and the cutting end point P₁₈. As shown in FIG. 5A, an end of the coordinate data for the partial patterns E, B, and A is set as a “stop code”, and an end of the coordinate data for the partial pattern G is set as an “end code”. The order data for the first cutting data corresponds to a cutting order in which the first sheet 20Ye to the fourth sheet 20YG are sequentially cut by the cutting device 11.

Based on the first cutting data, the control circuit 25 of the cutting device 11 controls the cutting unit to cut the corresponding one of the sheets 20Ye to 20YG in the order of the partial patterns C, D, E, B, A, and G described above. Specifically, the cutter cartridge 14 (cutter) is first moved relatively to the XY coordinates of the cutting start point P₀ by the X-axis movement mechanism and the Y-axis movement mechanism. Next, the blade edge of the cutter is caused to penetrate through the cutting start point P₀ of the partial pattern C on the first sheet 20Ye by the Z-axis movement mechanism. In this state, the blade edge is moved relatively to the coordinates by the X-axis movement mechanism and the Y-axis movement mechanism in such a way that the blade edge sequentially passes the points P₀, P₁, . . . , and the first sheet 20Ye is cut along the line segments C₁, C₂, . . . . Thus, the cutter is moved relatively to the cutting end point Pₙ, to thereby cut the sheet along the partial pattern C, i.e., the outline of “a left eye”. Similarly, the cutter is relatively moved based on the cutting-plane line data for the partial pattern D of “a right eye” and the partial pattern E of “a mouth”.

Upon completion of cutting of the cutting-plane line for the partial pattern E, the control circuit 25 moves the blade edge of the cutter to the origin O, which corresponds to a standby position of the carriage 15, based on the stop code, in a state where the blade of the cutter is spaced apart from the first sheet 20Ye. After that, in the cutting device 11, the second sheet 20B1 is set instead of the first sheet 20Ye, and the partial pattern B is also cut based on the cutting-plane line data for the partial pattern B. Thus, the second sheet 20B1, the third sheet 20Gr, and the fourth sheet 20YG, which correspond to the partial pattern B, the partial pattern A, and the partial pattern G, respectively, are sequentially set for the partial pattern B, the partial pattern A, and the partial pattern G, and the sheets are cut along the cutting-plane lines for the partial patterns. Upon completion of cutting of the cutting-plane line for the partial pattern G, the control circuit 25 causes the blade edge of the cutter to be spaced apart from the fourth sheet 20YG and moves the blade edge of the cutter to the standby position based on the end code. By the cutting operation described above, cutting-plane lines for cutting out an inside part of each of the partial patterns C, D, E, B, A, and G as an unnecessary part on the sheets 20Ye to 20YG can be formed.

The first cutting data is not limited to an example shown in FIG. 5A, but instead may include cutting-plane line data such as a border 41. The border 41 is an outline for cutting the outer edge of each sheet 20 (FIG. 4B). As described below, when the sheet 20 is cut along the border 41, parts surrounded by the border 41 represent the entire pattern M formed of a combination of the partial patterns A to G described above as a partial pattern H (see FIGS. 3B and 3C).

As shown in FIG. 5B, the second cutting data includes order data, feed data, coordinate data, stop code, end code, and data for display, like the first cutting data, and thus the differences between the first cutting data and the second cutting data will be mainly described.

First, in the second cutting data, the base sheet 20YG is provided with order data “0”. The partial pattern H corresponding to the order data “0” includes a square outline forming “a peripheral area” of the flower. As shown in FIG. 4B, the cutting-plane line for the partial pattern H is composed of four line segments H₁, H₂, H₃, and H₄. The cutting-plane line data for the partial pattern H includes feed data (F1x0, F1y0), first coordinate data (x1, y1), . . . , fourth coordinate data (x4, y4) respectively corresponding to the cutting start point P₀, the vertex P₁, . . . , and the cutting end point P₄.

The cutting-plane line data for the partial pattern G is set to the first sheet 20Gr corresponding to the order data “1”, and the cutting-plane line data for the partial pattern A is set to the second sheet 20B1 corresponding to the order data “2”. The cutting-plane line data for the partial pattern B is set to the third sheet 20Ye corresponding to the order data “3”, and the cutting-plane line data for the three partial patterns C to E is set to the fourth sheet 20B1 corresponding to the order data “4”.

The control circuit 25 of the cutting device 11 sequentially executes the cutting operation for the base sheet 20YG, the first sheet 20Gr, the second sheet 20B1, the third sheet 20Ye, and the fourth sheet 20B1 based on the second cutting data. Thus, cutting-plane lines for cutting out an outside part of each of the partial patterns H, G, and A to E as an unnecessary part on the sheets 20YG to 20B1 can be formed.

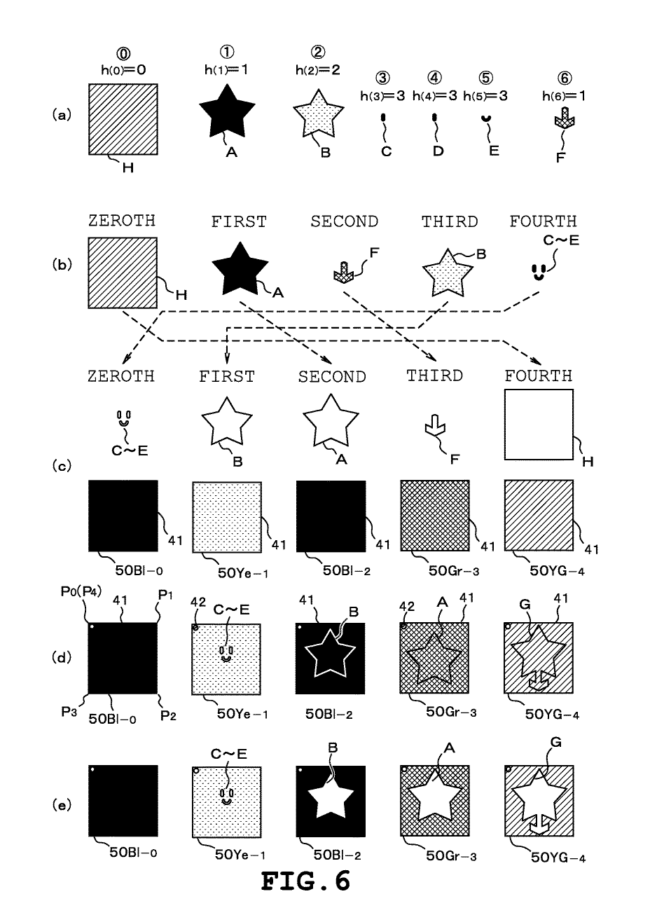

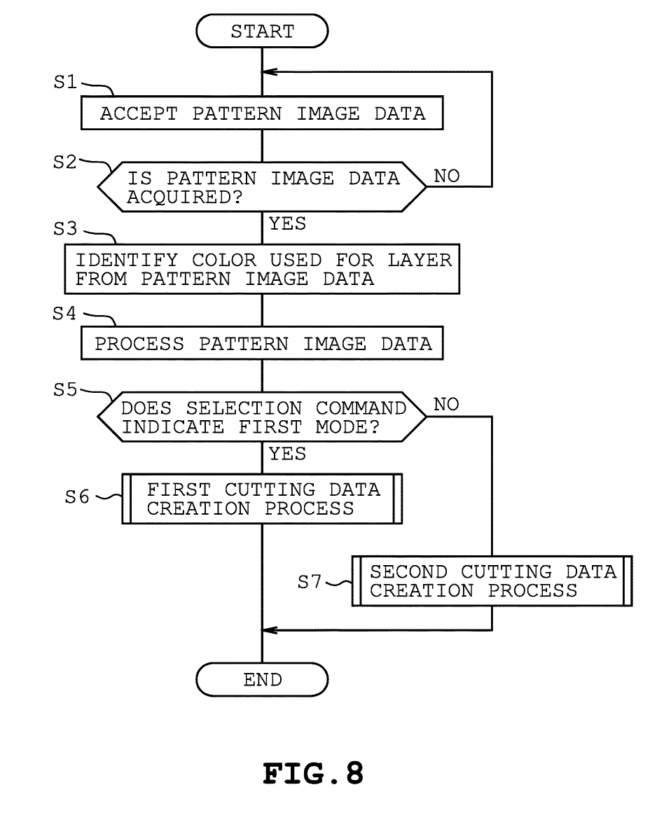

Next, the operation of the above-described configuration will be described with reference to FIGS. 6 to 15. The flowcharts of FIGS. 8 to 15 each show a flow of the cutting data creation program executed by the control circuit 5 of the cutting data creation device 1.

In the cutting data creation device 1, upon activation of the cutting data creation program, the control circuit 5 executes the process shown in FIG. 8. First, the control circuit 5 receives pattern image data to be the basis for the cutting data (step S1). Specifically, based on, for example, a user's input operation, the image scanner 10 is caused to read out the original drawing depicting the pattern of “flower”, so that the control circuit 5 acquires the pattern image data (YES in step S2). The pattern depicted in the original drawing is the pattern of “flower” for preparing the decorations 51 and 52 shown in FIG. 3A. In the pattern, “petals” are depicted in yellow; “a trimming part”, which corresponds to the outer periphery of the petals, “a left eye”, “a right eye”, and “a mouth” are each depicted in black; “leaves and a stalk” are depicted in green; and “a peripheral area” is depicted in yellow-green.

Next, the control circuit 5 performs a process for acquiring color information from the pattern image data (step S3). In this process, based on the pattern image data, a set of pixels in “petals” is identified as a yellow single-color region; a set of pixels in each of “a trimming part”, “a left eye”, “a right eye”, and “a mouth” is identified as a black single-color region; a set of pixels in “leaves and a stalk” is identified as a green single-color region; and the color of “a peripheral area” is identified as a yellow-green single-color region. Further, the control circuit 5 stores the identified four colors (yellow, black, green, and yellow-green) in the RAM 7 as the colors of layers 50Ye, 50B1, 50Gr, and 50YG to be described later.

The control circuit 5 processes the pattern image data (step S4). In this process, for example, when the size of the image of the pattern image data is larger than the size of the corresponding sheet 20 (adhesive layer 101), the size of the outer edge of the image is corrected so as to match the size of the outer edge of the sheet 20 having a rectangular shape.

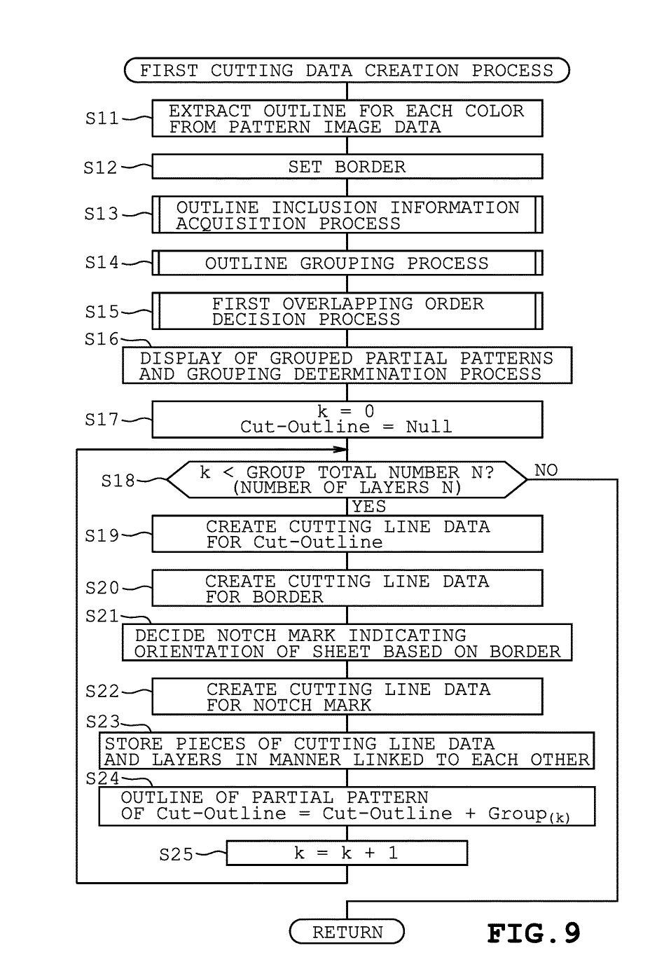

The control circuit 5 judges which one of a first mode and a second mode is selected based on a selection command from the input unit 4 such as the mouse 4b (step S5). Specifically, the control circuit 5 causes, for example, the display 3 to display to a mode selection screen (not shown) to select one of the first mode in which the entire pattern M is formed into a concave shape and the second mode in which the entire pattern M is formed into a convex shape. When the user selects the first mode by operating the mouse 4b or the like while viewing the mode selection screen (YES in step S5), the process shifts to the first cutting data creation process (see FIG. 9).

In the first cutting data creation process, the control circuit 5 processes the pattern image data by a well-known image processing technique and extracts outlines for each color (step S11). At this time, for example, as indicated in an order from the left side of FIG. 6(a), the outlines of “a peripheral area”, “a trimming part”, “petals”, “a left eye”, “a right eye”, “a mouth”, and “leaves and a stalk” are sequentially extracted. Each encircled numbers in FIG. 6(a) represents an extraction order, and the total number n of the extracted outlines is “7”. Each outline is extracted as vector data including coordinate data.

The control circuit 5 identifies “a peripheral area” corresponding to an extraction order “0” as the parts in which the yellow-green single-color region is surrounded by the outline for cutting the outer edge of the sheet 20, i.e., the partial pattern H. The control circuit 5 identifies “a trimming part” corresponding to an extraction order “1” as the partial pattern A in which the black single-color region is surrounded by the outline, and identifies “petals” corresponding to an extraction order “2” as the partial pattern B in which the yellow single-color region is surrounded by the outline. Further, the control circuit 5 identifies “a left eye”, “a right eye”, “a mouth” corresponding to extraction orders “3”, “4”, and “5”, respectively, as the partial patterns C, D, and E in which the black single-color region is surrounded by the outline, and identifies “leaves and a stalk” corresponding to an extraction order “6” as the partial pattern F in which the green single-color region is surrounded by the outline. Thus, the control circuit 5 can link the outlines to the layers 50YG to 50Gr, respectively, representing the respective single-color regions.

Next, the control circuit 5 performs a process for setting the border 41 for the layers 50YG to 50Gr (see step S12, FIG. 6(c)). In this exemplary embodiment, the outline of an outermost “peripheral area” is set as the square border 41. Further, the control circuit 5 shifts to an inclusion information acquisition process for acquiring information about the inclusion of the partial patterns A to F and H (step S13).

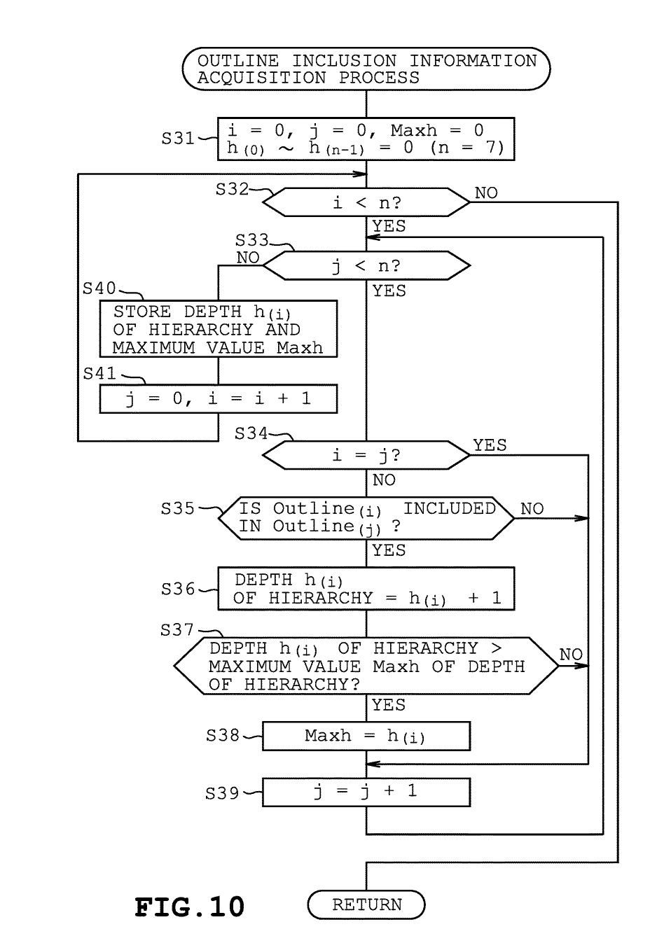

As shown in FIG. 10, in the inclusion information acquisition process, initial setting is performed (step S31). In this case, the control circuit 5 resets and initializes a counter i corresponding to each extraction order and another counter (target counter j) to “0” (i=j=0) so as to discriminate the inclusion relation between one of the plurality of partial patterns A to F, and H and another one of the plurality of partial patterns. The control circuit 5 resets h₍ᵢ₎, which represents the depth of a hierarchy of each partial pattern, and Maxh, which represents a maximum value of the depth h₍ᵢ₎ of the hierarchy, to “0”. The depth h₍ᵢ₎ of a hierarchy represents the number of the partial patterns to be included as the depth of a hierarchy. When the hierarchy of the partial pattern H of “a peripheral area” is a highest hierarchy (depth 0), the depths of the hierarchies of the partial patterns A to F and H are represented by depths h₍₀₎ to h₍ₙ₋₁₎, respectively.

The control circuit 5 discriminates the inclusion relation of the partial patterns on condition that the values of the counter i and the target counter j are smaller than the total number n of outlines (YES in steps S32 and S33) and the values of the counters i and j do not match (NO in step S34). At this time, the value of each of the counters i and j is “0” (YES in step S34), which prevents the inclusion relation between the partial patterns H and H corresponding to the extraction order “0” from being discriminated. Accordingly, the control circuit 5 increments the target counter j by 1 in step S39 so as to change the object to be discriminated for the partial pattern H, and returns to step S33.

In this case, since the value of the target counter j is smaller than the total number n of outlines and does not match the value of the counter i, the conditions for steps S33 and S34 are satisfied. At this time, the control circuit 5 discriminates whether or not the outline of the partial pattern H corresponding to an extraction order “i” as one Outline₍ᵢ₎ is included in the outline of the partial pattern A corresponding to an extraction order “j” as another Outline₍ⱼ₎ (step S35). Outline₍ᵢ₎ or Outline₍ⱼ₎ is information representing a set of vector data on the outline of the partial pattern corresponding to the extraction order “i” or “j”. At this time, the control circuit 5 discriminates that the Outline₍₀₎ of the partial pattern H is not included in the Outline₍₁₎ of the partial pattern A based on the coordinate data of each outline (NO in step S35; see FIG. 6(a)).

After that, the control circuit 5 determines that the target counter j is incremented by 1 and indicates “2” in step S39 (j=2), and returns to step S33. Also when the value of the target counter j is “2”, the control circuit 5 determines that the conditions for the steps S33 and S34 are satisfied, and discriminates that the Outline₍₀₎ of the partial pattern H corresponding to the extraction order “i” of 0 is not included in the Outline₍₀₎ of the partial pattern B corresponding to the extraction order “j” of 2 (NO in step S35; see FIG. 6(a)).

Thus, the Outline₍₀₎ of the partial pattern H has a shape surrounding other partial patterns A, B, . . . , and F, so that it is not discriminated that the Outline₍₀₎ of the partial pattern H is included in the Outline₍ⱼ₎ of the other partial patterns A, B . . . (YES in step S35). Therefore, the control circuit 5 repeatedly executes steps S33 to S35 and S39 for the Outline₍₀₎ of the partial pattern H and discriminates the inclusion relation with the Outline₍₀₎ of the partial pattern F corresponding to the extraction order “j” of 6, but does not execute step S36. Accordingly, the hierarchy of the partial pattern H remains at the depth h₍₀₎ of 0. Therefore, when the control circuit 5 determines that the value of the target counter j reaches the total number n of outlines of 7 (NO in step S33), the control circuit 5 sets the hierarchy of the partial pattern H to the depth h₍₀₎ of 0, and stores the set hierarchy in the RAM 7 as the maximum value (Maxh=0) of the depth of the hierarchy (step S40).

Next, the control circuit 5 resets the target counter j to “0” and increments the counter i by 1 (step S41), and executes the steps S32 to S39 for the partial pattern A corresponding to the extraction order “i” of 1.

In this case, the counter i indicates “1” and the target counter j indicates “0” (YES in steps S32 and S33, and NO in step S34). Accordingly the control circuit 5, discriminates the inclusion relation between the Outline₍₁₎ of the partial pattern A and the Outline₍₀₎ of the partial pattern H (step S35). When the control circuit 5 determines that the Outline₍₁₎ of the partial pattern A is included in the Outline₍₀₎ of the partial pattern H (YES in step S35), the control circuit 5 increments the depth h₍ᵢ₎ of the hierarchy of the partial pattern A by 1 (step S36). At this time, the control circuit 5 determines that the depth (h₍₁₎=1) of the hierarchy of the partial pattern A is larger than the maximum value (Maxh=0) of the depth h₍ᵢ₎ at the time (YES in step S37), the control circuit 5 sets (updates) the maximum value Maxh to the value “1” of the depth of the hierarchy of the partial pattern A (step S38).

After that, the control circuit 5 increments the value of the target counter j one by one for the partial pattern A corresponding to the extraction order “i” of 1 (step S39), and executes the process by sequentially changing the target for discriminating the inclusion relation. However, when the target counter j indicates 1, i=j holds (YES in step S34). When the target counter j indicates 2 to 6, the Outline₍₁₎ of the partial pattern A is not included in the Outline₍₀₎ to Outline₍₆₎ of the other partial patterns B to F (NO in step S35; see FIG. 6(a)). Therefore, the control circuit 5 repeatedly executes the steps S33 to S35 and S39 for the Outline₍ᵢ₎ of the partial pattern A, and discriminates the inclusion relation with the Outline₍₆₎ of the partial pattern F corresponding to the extraction order “j” of 6. When the value of the target counter j reaches 7 (NO in step S33), the control circuit 5 stores the depth (h₍₁₎=1) of the hierarchy of the partial pattern A and the maximum value (Maxh=1) of the depth of the hierarchy in the RAM 7 (step S40).

Next, the control circuit 5 resets the target counter j to “0” and increments the counter i by 1 (step S41), and executes the steps S32 to S39 for the partial pattern B corresponding to the extraction order “i” of 2. In this case, since the counter i indicates “2” and the target counter j indicates “0” (YES in steps S32 and S33 and NO in step S34), the control circuit 5 discriminates the inclusion relation between the Outline₍₀₎ of the partial pattern B and the Outline₍₀₎ of the partial pattern H (step S35). When the control circuit 5 determines that the Outline₍₀₎ of the partial pattern B is included in the Outline₍₀₎ of the partial pattern H (YES in step S35), the control circuit 5 increments the depth h₍₂₎ of the hierarchy of the partial pattern B by 1 and sets the depth to 1 (step S36). The depth (h₍₂₎=1) of the hierarchy of the partial pattern B at the time is the same as the maximum value (Maxh=1) of the depth h₍ᵢ₎ at the time (NO in step S37).

Further, the control circuit 5 increments the value of the target counter j by 1 and set the value to 1 (step S39), and discriminates the inclusion relation between the Outline₍₀₎ of the partial pattern B and the Outline₍₁₎ of the partial pattern A (step S33 to S35). The control circuit 5 determines that the Outline₍₀₎ of the partial pattern B is included in the Outline₍₁₎ of the partial pattern A (YES in step S35), and increments the depth h₍₂₎ of the hierarchy of the partial pattern B by 1 and sets the depth to 2 (step S36). At this time, the control circuit 5 determines that the depth (h₍₂₎=2) of the hierarchy of the partial pattern B is larger than the maximum value (Maxh=1) of the depth h₍ᵢ₎ at the time (YES in step S37), and updates the maximum value Maxh with the value “2” of the depth of the hierarchy of the partial pattern B.

After that, the control circuit 5 increments the value of the target counter j one by one for the partial pattern B corresponding to the extraction order “i” of 2 (step S39), executes the process by sequentially changing the target for discriminating the inclusion relation. However, when the target counter j indicates 2, i=j holds (YES in step S34). When the target counter j indicates 3 to 6, the Outline₍₀₎ of the partial pattern B is not included in the Outline₍₀₎ to Outline₍₆₎of the other partial patterns C to F (NO in step S35). Therefore, the control circuit 5 repeatedly executes the steps S33 to S35 and S39 for the Outline₍₀₎ of the partial pattern B. When the value of the target counter j reaches 7 (NO in step S33), the depth (h₍₂₎=2) of the hierarchy of the partial pattern B and the maximum value (Maxh=2) of the depth of the hierarchy are stored in the RAM 7 (step S40).

Further, the control circuit 5 increments the counter i one by one for the partial patterns C to F corresponding to the extraction order “i” of 3 to 6, respectively (step S41), discriminates the inclusion relation with the other partial patterns in the same manner as the partial patterns H, A, and B, executes the process (steps S32 to S40) for obtaining the depths h₍₃₎ to h₍₆₎ of the hierarchies and the maximum value Maxh (step S32 to S40). In this case, the Outline₍₃₎ of the partial pattern C corresponding to the extraction order “i” of 3 is included in three Outline₍₀₎ to Outline₍₂₎ of the partial patterns H, A, and B. Accordingly, the depth h₍₃₎ of the hierarchy of the partial pattern C is 3, and the maximum value Maxh of the depth of the hierarchy is updated to 3 (step S38). The depth h₍₄₎ of the hierarchy of the pattern D is 3; the depth h₍₅₎ of the hierarchy of the partial pattern E is 3; and the depth h₍₆₎ of the hierarchy of the partial pattern F is 1 (these are shown in FIG. 6(a)). As a result, the maximum value Maxh of the depth of the hierarchy is 3. Thus, the control circuit 5 stores all the partial patterns H and A to F in such a manner that the partial patterns are linked to the depths of the hierarchies (step S40). When the value of the counter i reaches 7 (steps S41; NO in step S32), the process returns to step S14.

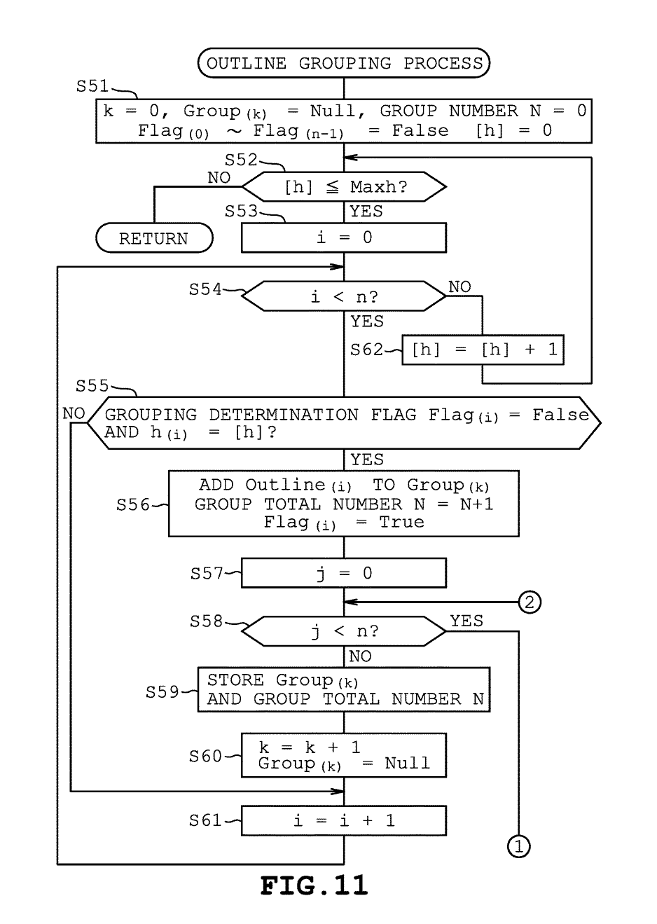

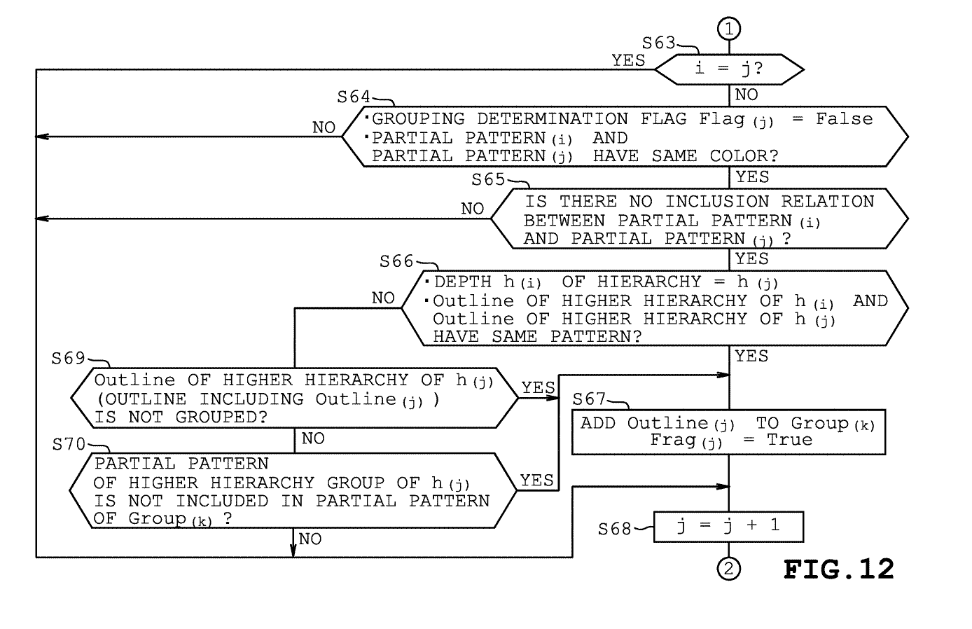

FIGS. 11 and 12 show the grouping process of step S14. In step S51 of FIG. 11, the control circuit 5 resets a group counter k to “0” (k=0), and sets Group₍ₖ₎ of Outline₍ᵢ₎ to Null. Group₍ₖ₎ represents a set of Outline(i) which is obtained by grouping, as one group, specific partial patterns from the partial patterns H and A to F. The control circuit 5 resets the counter to “0” to obtain the total value N of the groups (N=0), and sets a grouping determination flag Flag₍ᵢ₎ of each partial pattern to False respectively. When the grouping determination flag Flag₍ᵢ₎ is set to False, the grouping determination flag Flag₍ᵢ₎ indicating that the partial pattern belonging to the Group₍ₖ₎ is not identified. When the grouping determination flag Flag₍ᵢ₎ is set to True, the grouping determination flag Flag₍ᵢ₎ is information indicating that the partial pattern belonging to the Group₍ₖ₎ is identified. The control circuit 5 substitutes 0 into a variable [h] representing the depth of the hierarchy, and specifies the partial patterns to be grouped in a range from a highest hierarchy ([h]=0) to a lowest hierarchy ([h]=Maxh=3).

Specifically, at the highest hierarchy corresponding to the value “0” of the variable [h] (YES in step S52), the control circuit 5 resets the counter i to “0” (i=0 in step S53; YES in step S54). Accordingly, the control circuit 5 determines whether or not the grouping determination flag Flag₍₀₎ is set to False for the partial pattern H corresponding to the extraction order “i” of 0, and judges whether or not the depth (h₍₀₎=0) of the hierarchy obtained in the step S13 is equal to the variable [h] (step S55).

The control circuit 5 determines that the grouping determination flag Flag₍₀₎ for the partial pattern H to False and the depth h₍₀₎ of the hierarchy of the partial pattern H is 0 which is equal to the variable [h] (YES in step S55). At this time, the control circuit 5 determines that the Outline₍₀₎ of the partial pattern H belongs to the zeroth Group₍₀₎ of the highest hierarchy, adds (identifies) the Outline₍₀₎ of the partial pattern H in step S56, and increments the group total number N by 1 (N=1). The control circuit 5 identifies the Group₍₀₎ of the partial pattern H and sets the grouping determination flag Flag₍₀₎ for the partial pattern H to True.

The control circuit 5 resets the target counter j to “0” (step S57). Further, the control circuit 5 judges whether or not to add another partial pattern to the zeroth Group₍₀₎ on condition that the value of the target counter j is smaller than the total number n of outlines (YES in step S58) and the values of the counters i and j do not match (NO in step S63 of FIG. 12), (steps S64 to S66, S69, and S70). At Step 63, the control circuit 5 judges the counters i and j match or not. At the time, since the values of the counters i and j are 0 (YES in step S63), whether or not to add the same partial pattern H is not judged. Accordingly, the control circuit 5 increments the target counter j by 1 and sets the value of the target counter to 1 (j=1) in step S68 so as to change the object to be judged, and returns to step S58.

In this case, the value of the target counter j is smaller than the total number n of outlines and does not match the value of the counter i. Accordingly, the conditions for steps S58 and S63 are satisfied. At this time, the control circuit 5 judges whether a grouping determination flag Flag₍₁₎ is set to False for the partial pattern A corresponding to the extraction number “j” of 1, and judges whether color information is the same as the color information about the partial pattern H belonging to the zeroth Group₍₀₎ (step S64). The control circuit 5 determines that the grouping determination flag Flag₍₁₎ for the partial pattern A is set to False but the color, i.e., black, of the partial pattern A, is different from the color, i.e., yellow-green, of the partial pattern H of the zeroth Group₍₀₎ (NO in step S64).

After that, the control circuit 5 determines that the target counter j is incremented by 1 and set to 2 in step S68 (j=2), and returns to step S58. Also when the value of the target counter j is 2, the control circuit 5 determines that the conditions for the steps S58 and S63 are satisfied and a grouping determination flag Flag₍₂₎ is set to False for the partial pattern B corresponding to the extraction order “j” of 2 but the color, i.e., yellow, of the partial pattern B is different from the color, i.e., yellow-green of the partial pattern H of the zeroth Group₍₀₎ (NO in step S64).

Thus, since yellow-green of the partial pattern H belonging to the zeroth Group₍₀₎ is not used in the other partial patterns A, B, . . . , and F, the judgment result in step S64 does not indicate YES. Accordingly, even when the control circuit 5 repeatedly executes steps S58, S63, S64, and S68 for the zeroth Group₍₀₎ and makes a judgment of the color information of the partial pattern F corresponding to the extraction order “j” of 6, step S67 is not executed. Accordingly, the partial patterns other than the partial pattern H are not added to the zeroth Group₍₀₎. Therefore, when the control circuit 5 determines that the value of the target counter j reaches the total number n of outlines to 7 (NO in step S58), the control circuit 5 stores the Outline₍₀₎ of the partial pattern H identified as the zeroth Group₍₀₎ in the RAM 7 and stores the value “1” of the group total number N at the time in the RAM 7 (step S59).

Next, the control circuit 5 increments the group counter k by 1, sets the Group₍ₖ₎ to Null (step S60), and sets the target to the first Group₍₁₎. Further, the control circuit 5 determines that the counter i is incremented by 1 (step S61; YES in step S54) and the grouping determination flag Flag₍₁₎ of the partial pattern A corresponding to the extraction order “i” of 1 is set to False, and determines that the depth h₍ᵢ₎ of the hierarchy of the partial pattern A is “1” which is different from the value “0” of the variable [h] (NO in step S55). Specifically, since there is no partial pattern corresponding to the depth h₍ᵢ₎ of the hierarchy other than the partial pattern H, when the control circuit 5 repeatedly executes step S54, S55, and S61 for the partial patterns A to F respectively indicated by the values “1” to “6” of the counter i, the judgment result of each step indicates NO.

As a result, when the value of the counter i reaches 7 (NO in step S54), the control circuit 5 substitutes the value ([h]+1) obtained by incrementing the variable [h] by 1 and sets the variable [h] to “1” (step S62; YES in step S52). Further, the control circuit 5 resets the counter i to “0” (step S53; YES in step S54). At this time, the grouping determination flag Flag₍₀₎ of the partial pattern H corresponding to the extraction order “i” of 0 is set to True (NO in step S55), and thus the counter i is incremented by 1 and sets the counter i to 1 (step S61; YES in step S54). Thus, the control circuit 5 judges whether or not the grouping determination flag Flag₍₀₎ of the partial pattern A corresponding to the extraction order “i” of 1 is set to False, and judges whether or not the depth (h₍₁₎=1) of the hierarchy of the partial pattern A is equal to the variable [h] (step S55).

The grouping determination flag Flag₍₁₎ of the partial pattern A is set to False and the depth h₍₁₎ of the hierarchy of the partial pattern A is “1” which is equal to the variable [h] (YES in step S55). Accordingly, the control circuit 5 identifies the Outline₍₁₎ of the partial pattern A that belongs to the first Group₍₁₎ in step S56, and increments the group total number N by 1 and sets the group total number N to “2”, or sets grouping determination flag Flag₍₁₎ for the partial pattern A to True.

Further, the control circuit 5 resets the target counter j to “0” as described above (step S57), and sequentially judges whether or not to add the other partial patterns H and B to F to the first Group₍₀₎ on condition that the value of the counter j is smaller than the total number n of outlines (step S58) and the values of the counters i and j do not match (step S63). In this regard, black of the partial pattern A belonging to the first Group₍₀₎ is used in the partial patterns C to E for which the grouping determination flag is set to False. Accordingly, when the value of the target counter j is 3, 4, or 5, the control circuit 5 determines that the partial patterns C to E respectively corresponding to the extraction order “j” of 3 to 5 have the same color as that of the partial pattern A (YES in step S64).

Since the control circuit 5 determines that the Outline₍₃₎ to Outline₍₅₎ of the partial patterns C to E are included in the Outline₍₀₎ of the partial pattern A (NO in step S65), the partial patterns other than the partial pattern A are not added to the first Group₍₀₎. Therefore, the control circuit 5 repeatedly executes steps S58, S63, S64, S65, and S68 for the first Group₍₀₎. When the judgment up to the partial pattern F corresponding to the extraction order “j” of 6 is finished (NO in step S58), the Outline₍₁₎ of the partial pattern A identified as the first Group₍₀₎ is stored in the RAM 7 and the value “2” of the group total number N at the time is stored in the RAM 7 (step S59).

Next, the control circuit 5 increments the group counter k by 1, sets the Group₍ₖ₎ to Null (step S60), and sets the target to the second Group₍₂₎. Further, the control circuit 5 determines that the counter i is incremented by 1 (step S61; YES in step S54) and the grouping determination flag Flag₍₂₎ of the partial pattern B corresponding to the extraction order “i” of 2 is set to False, and determines that the depth h₍₂₎ of the hierarchy of the partial pattern B is “2” which is different from the value “1” of the variable [h] (NO in step S55). Specifically, since only the partial pattern A and the partial pattern F have the depth h₍ᵢ₎ “1” of the hierarchy, the control circuit 5 repeatedly executes steps S54, S55, and S61 for the partial patterns A to F respectively indicated by the values “2” to “6” of the counter i. When the value of the counter i is “6”, the result of the judgment in step S55 indicates “YES”.

Thus, the control circuit 5 identifies the Outline₍₆₎ of the partial pattern F corresponding to the depth h₍₆₎ of the hierarchy belongs to the second Group₍₂₎ in step S56, and increments the group total number N by 1 and sets the group total number N to 3, and sets a grouping determination flag Flag₍₆₎ for the partial pattern F to True.

Further, the control circuit 5 resets the target counter j to “0” as described above (step S57), and sequentially judges whether or not to add the other partial patterns H and A to H to the second Group₍₂₎ on condition that the value of the counter j is smaller than the total number n of outlines and the values of the counters i and j do not match (steps S58 and S63). In this regard, green of the partial pattern F belonging to the second Group₍₂₎ is not used in the other partial patterns H and A to E. Accordingly, the control circuit 5 repeatedly executes steps S58, S63, S64, and S68 for the second Group₍₂₎, but the partial patterns other than the partial pattern F are not added to the second Group₍₂₎. Therefore, when the value of the target counter j reaches 7 (NO in step S58), the control circuit 5 stores the Outline₍₆₎ of the partial pattern F identified as the second Group₍₂₎ in the RAM 7, and stores the value “3” of the group total number N at the time in the RAM 7 (step S59).

Next, the control circuit 5 increments the group counter k by 1, sets the Group₍ₖ₎ to Null (step S60), and sets the target to the third Group₍₃₎. Further, the control circuit 5 increments the value of the counter i and sets the value to 7 (step S61; NO in step S54), and substitutes the value ([h]+1) obtained by incrementing the variable [h] by 1 and sets the variable [h] to 2 (step S62; YES in step S52). Then, the control circuit 5 temporarily resets the counter i to “0” (step S53), and executes the steps S54, S55, and S61 to thereby increment the counter i by 1. When the value of the counter i is “2”, the control circuit 5 determines the grouping determination flag Flag₍₀₎ for the partial pattern B is set to False and the depth (h₍₂₎=2) of the hierarchy is equal to the variable [h] (YES in step S55).

Thus, the control circuit 5 identifies that the Outline₍₂₎ of the partial pattern B corresponding to the depth h₍₂₎ of the hierarchy belongs to the third Group₍₃₎ in step S56, and increments the group total number N by 1 and sets the group total number N to 4, and sets the grouping determination flag Flag₍₀₎ for the partial pattern B to True.

The control circuit 5 executes the steps S57, S58, S63, S64, and S68, thereby incrementing the target counter j one by one and sequentially judging whether or not the partial patterns C to E for which the grouping determination flag is set to False are added to the third Group₍₃₎. In this regard, yellow of the partial pattern B belonging to the third Group₍₃₎ is not used in the partial patterns C to E (NO in step S64). Therefore, the control circuit 5 stores the Outline₍₂₎ of the partial pattern B in the RAM 7, without adding the other partial patterns C to E as the third Group₍₃₎, and stores the value “4” of the group total number N at the time in the RAM 7 (step S59).

Next, the control circuit 5 increments the group counter k by 1 and sets the Group₍ₖ₎ to Null (step S60), and sets the target to the fourth Group₍₄₎. Further, the control circuit 5 executes the steps S61, S54, and S55, thereby incrementing the counter i one by one, and judging whether or not the partial pattern corresponding to the depth h₍ᵢ₎ of the hierarchy is present for the partial patterns C to E for which the grouping determination flag is set to False (step S54). Since only the partial pattern B is the partial pattern corresponding to the depth “2” of the hierarchy (NO in step S54), the control circuit 5 substitutes the value obtained by incrementing the variable [h] by 1 and sets the variable [h] to 3 (step S62; YES in step S52). Further, the control circuit 5 temporarily resets the counter i to “0” (step S53; YES in step S54), and executes the steps S54, S55, and S61, thereby incrementing the counter i one by one and judging that, when the value of the counter i is “3”, the grouping determination flag Flag₍₃₎ for the partial pattern C is set to False and the depth (h₍₃₎=3) of the hierarchy is equal to the variable [h] (YES in step S55).

Thus, the control circuit 5 identifies that the Outline₍₃₎ of the partial pattern C corresponding to the depth h₍₃₎ of 3 of the hierarchy belongs to the fourth Group₍₄₎ in step S56, and increments the group total number N by 1 and sets the group total number N to 5, and sets the grouping determination flag Flag₍₃₎ for the partial pattern C is set to True. Further, the control circuit 5 executes the steps S57, S58, S63, S64, and S68, thereby incrementing the target counter j one by one and sequentially judging whether or not the partial patterns D and E for which the grouping determination flag is set to False have the same color as that of the partial pattern C of the fourth Group₍₄₎. In this regard, since the color of the partial pattern D is the same as the color, i.e., black, of the partial pattern C, when the value of the target counter j is “4”, the result of the judgment by the control circuit 5 in step S64 indicates YES. Then, the control circuit 5 judges whether or not there is an inclusion relation between the Outline₍₁₎ of the partial pattern D and the Outline₍₃₎ of the partial pattern C (step S65).

The outlines of the partial patterns C and D are spaced apart from each other and form closed outlines as described above. Accordingly, the control circuit 5 determines that there is no inclusion relation between the outlines of the partial pattern D and the partial pattern C (YES step S65). Further, the control circuit 5 judges whether or not the depth of the hierarchy of the partial pattern D is the same as that of the partial pattern C, and judges whether or not the partial pattern including the partial pattern D is the same as the partial pattern including the partial pattern C (step S66). In this case, the control circuit 5 compares the depth h₍₄₎ of the hierarchy of the partial pattern D with the depth h₍₃₎ of the hierarchy of the partial pattern C. When determining that the hierarchy depths of the partial patterns C and D are “3” and the partial pattern including the partial patter C is the same as the partial pattern including the partial pattern D (YES in step S66), the control circuit 5 determines that the Outline₍₀₎ of the partial pattern D belongs to the fourth Group₍₄₎ and adds the Outline₍₄₎ of the partial pattern D to the fourth Group₍₄₎ (step S67). Further, the control circuit 5 sets a grouping determination flag Flag₍₀₎ for the partial pattern D to True.

Further, the control circuit 5 increments the target counter j by 1 and sets the value to 5 (step S68; YES in steps S58 and S63), and judges whether or not to also add the partial pattern E to the fourth Group₍₄₎. The color of the partial pattern E is black which is identical to the color of the partial pattern D (YES in step S64). There is no inclusion relation between the outline of the partial pattern E and the outline of the partial pattern C (YES in step S65). The depth h₍₅₎ of the hierarchy of the partial pattern E is “3” which is the same as that of the partial pattern C. The partial pattern including the partial pattern C is the same as the partial pattern including the partial pattern E (YES in step S66). Therefore, the control circuit 5 determines that the Outline₍₅₎ of the partial pattern E belongs to the fourth Group₍₄₎ and adds the Outline₍₅₎ of the partial pattern E to the fourth Group₍₄₎ (step S67), and sets a grouping determination flag Flag₍₅₎ to True. A plurality of partial patterns having different hierarchy depths (NO in step S66) may be grouped as one group. However, the steps S69 and S70 will be described in detail later.

Thus, when all the grouping determination flags Flag₍₀₎ to Flag₍₆₎ are set to True (NO in step S64) and the value of the target counter j reaches 7 (NO in step S58), the control circuit 5 stores the updated contents of the Outline₍₃₎ to Outline₍₅₎ of the partial patterns C to E, which are identified (updated) as the fourth Group₍₄₎, in the RAM 7, and stores the value “5” of the group total number N at the time in the RAM 7 (step S59).

Next, the control circuit 5 increments the group counter k by 1, sets the Group₍ₖ₎ to Null (step S60), and sets the Group₍₀₎ to the fifth Groups). All the grouping determination flags Flag₍₀₎ to Flag₍₆₎ are set to True (NO in step S55). Accordingly, the control circuit 5 repeatedly executes steps S61, S54, and S55. When the value of the counter i reaches 7 (NO in step S54), the control circuit 5 substitutes the value ([h]+1) obtained by incrementing the variable [h] by 1 (step S62), and sets the variable [h] to 4. At this time, the control circuit 5 determines that the value of the variable [h] exceeds the value “3” of a lowest hierarchy Maxh, i.e., the grouping process for all hierarchies is completed (NO in step S52), and returns to step S15.

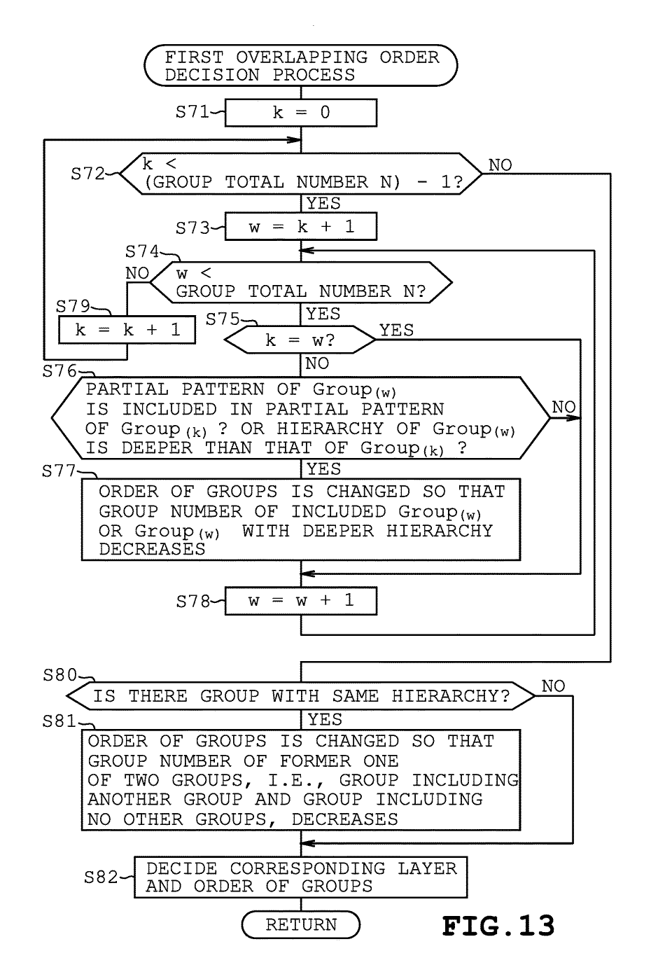

FIG. 13 shows a first overlapping order decision process of step S15. In the first overlapping order decision process, for each of Group₍₀₎ to Group₍₀₎ (the zeroth to fourth groups shown in FIG. 6(b)) obtained in step S14, the order of groups is changed in such a manner the plurality of sheets 20 having the entire pattern M formed in a concave shape is superimposed. The change of the order of groups is performed based on the inclusion relation between the partial pattern belonging to one Group₍ₖ₎ and the partial pattern belonging to another Group_{(w)}.

Specifically, in step S71 of FIG. 13, the control circuit 5 resets the group counter (counter k) corresponding to the group number of one group (k) to 0. Next, in step S72, the control circuit 5 judges whether or not the counter k is smaller than a group total number N−1. First, the counter k is smaller than the group total number N−1, and thus the process shifts to step S73. However, when the value of the counter k is equal to or greater than the group total number N−1, the process shifts to step S80. In step S73, the control circuit 5 increments a group counter (target counter w) corresponding to the group number of another Group_{(w)} to the counter k by 1 (w=k+1) and sets the value of the target counter to 1. Next, in step S74, the control circuit 5 judges whether or not the target counter w is smaller than the group total number N. When the target counter w is smaller than the group total number N, the process shifts to step S75. However, when the value of the target counter w is equal to or greater than the group total number N, the process shifts to step S79. In step S75, the control circuit 5 judges whether or not the counter k is equal to the target counter w. When the value of the counter k is equal to the value of the target counter w, the process shifts to step S78. When the counter k is not equal to the target counter w, the process shifts to step S76.

In step S76, the control circuit 5 discriminates whether or not the partial pattern A of the first Group₍₁₎ corresponding to the value of the target counter w is included in the partial pattern H of the zeroth Group₍₀₎ corresponding to the value of the counter k, and discriminates whether or not the hierarchy of the partial pattern A is deeper than the hierarchy of the partial pattern H. In this case, the control circuit 5 discriminates that the Outline₍₁₎ of the partial pattern A is included in the Outline₍₀₎ of the partial pattern H, based on the coordinate data of the outlines of the partial patterns H and A. It is discriminated that the depth (see h₍₁₎ shown in FIG. 6(a)) of the hierarchy of the partial pattern A is 1 which is larger than the depth (h₍₀₎=0) of the hierarchy of the partial pattern H (YES in step S76). Accordingly, the control circuit 5 changes the order of groups in such a manner that the number of Group₍₁₎ of the partial pattern A is smaller than the number of Group₍₀₎ of the partial pattern H (the partial pattern A is concave backward with respect to the partial pattern H) (step S77). Thus, the order of groups is changed in such a manner that the included (or deep-hierarchy) partial pattern A is set to zeroth Group₍₀₎ and the partial pattern H is set to the first Group₍₁₎.

Next, the control circuit 5 increments the value of the target counter w by 1 and sets the value to 2 in step S78. After that, the process returns to step S74, and the same process is repeated. Specifically, the control circuit 5 discriminates the inclusion relation and the hierarchy depth relation between the partial pattern F of the second Group₍₂₎ as the object to be discriminated and the partial pattern A of the zeroth Group₍₀₎ corresponding to the value of the counter k (step S76). In this case, the partial pattern F is not included in the partial pattern A, and the depth of the hierarchy of the partial pattern F is the same as that of the partial pattern A (NO in step S76). Accordingly, the order of the partial pattern F of the second Group₍₂₎ and the order of the partial pattern A of the zeroth Group₍₀₎ are not changed at the time. When the judgment result in step S76 indicates NO, the process shifts to step S78.

After the control circuit 5 increments the value of the target counter w by 1 and sets the value of the target counter w to 3 in step S78, the control circuit 5 returns to step S74 and repeats the same process. Specifically, the inclusion relation and the hierarchy depth relation between the partial pattern B of the third Group₍₃₎ and the partial pattern A of the zeroth Group₍₀₎ are discriminated (step S76). In this case, the partial pattern B is included in the partial pattern A, and the hierarchy of the partial pattern B is deeper than the partial pattern A (YES in step S76). Accordingly, the control circuit 5 changes the order of groups in such a manner that the partial pattern B is set to the zeroth Group₍₀₎ and the partial pattern A is set to the third Group₍₃₎. After the control circuit 5 increments the value of the target counter w by 1 and sets the value of the target counter w to 4, the control circuit 5 returns to step S74 and repeats the same process. Specifically, the control circuit 5 discriminates the inclusion relation and the hierarchy depth relation between the partial patterns C to E of the fourth Group₍₄₎ and the partial pattern B of the zeroth Group₍₀₎ (step S76). In this case, the partial patterns C to E are each included in the partial pattern B, the hierarchy of each of the partial patterns C to E is deeper than that of the partial pattern B (YES in step S76). According, the control circuit 5 changes the order of groups in such a manner that the partial patterns C to E to the zeroth Group₍₀₎ and the partial pattern B is set to the fourth Group₍₄₎.

Thus, the value of the counter k remains at 0 and the value of the target counter w is incremented one by one (step S78). When the value of the group total number N reaches “5” (NO in step S74), the partial patterns C to E belong to the zeroth Group₍₀₎; the partial pattern H belongs to the first Group₍₁₎; the partial pattern F belongs to the second Group₍₂₎; the partial pattern A belongs to the third Group₍₃₎; and the partial pattern B belongs to the fourth Group₍₄₎.

Further, the control circuit 5 increments the value of the counter k by 1 and sets the value to 1 (step S79), increments the value of the target counter w to the counter k by 1 and sets the value to 2 (step S73), sequentially discriminates the inclusion relation and the hierarchy depth relation between the partial pattern of the first Group₍₁₎ corresponding to the value of the counter k and the partial patterns of the second Group₍₂₎, third Group₍₃₎, and fourth Group₍₄₎, and changes the order of groups (step S74 to S78). In this process, when the value of the target counter w is 4, the inclusion relation and the hierarchy depth relation between the partial pattern B of the fourth Group₍₄₎ and the partial pattern F of the first Group₍₁₎ are discriminated. In this case, the partial pattern B is not included in the partial pattern F, and the hierarchy of the partial pattern B is deeper than that of the partial pattern F (YES in step S76). Accordingly, the control circuit 5 changes the order of groups in such a manner that the partial pattern B is set to the first Group₍₁₎ and the partial pattern F is set to the fourth Group₍₄₎. As a result, when the value of the target counter w reaches 5 (NO in step S74), the partial patterns C to E belong to the zeroth Group₍₀₎; the partial pattern B belongs to the first Group₍₁₎; the partial pattern H belongs to the second Group₍₂₎; the partial pattern A belongs to the third Group₍₃₎; and the partial pattern F belongs to the fourth Group₍₄₎.

Further, the control circuit 5 increments the value of the counter k one by one as described above (k=2, 3, step S79), and repeatedly executes the steps S74 to S78 for the partial patterns of the second Group₍₂₎ and the third Group₍₃₎, thereby sequentially discriminating the inclusion relation and the hierarchy depth relation between the third Group₍₃₎ and the fourth Group₍₄₎ and changing the order of groups. As a result, when the value of the counter k reaches N−1 (i.e., 4) (NO in step S72), the order of groups is changed in such a manner that the partial patterns C to E belong to the zeroth Group₍₀₎; the partial pattern B belongs to the first Group₍₁₎; the partial pattern A belongs to the second Group₍₂₎; the partial pattern F belongs to the third Group₍₃₎; and the partial pattern H belongs to the fourth Group₍₄₎.

By changing the order of groups, smaller group numbers are assigned in an order from a lowest hierarchy so as to correspond to the depth of the hierarchy of each group (partial pattern). Further, the control circuit 5 judges whether or not there are groups having the same hierarchy depth among the groups (step S80). Specifically, for example, the depth of the hierarchy of each of the second Group₍₂₎ and the third Group₍₃₎ (partial patterns A and F) is (YES). In this case, if the group number of the partial pattern A including the other partial patterns B and C to E is not smaller than the group number of the partial pattern F which does not include the other partial patterns B and C to E, the other partial patterns B and C to E cannot be sequentially displayed in a concave shape.

Therefore, in step S81, the control circuit 5 changes the order of groups in such a manner that the group number of the former one of the partial patterns of the group of the partial pattern including other partial patterns and the group of the partial pattern including no other partial patterns is smaller than the group number of the latter partial pattern. In this exemplary embodiment, the former partial pattern A belongs to the second Group₍₂₎ and the latter partial pattern F belongs to the third Group₍₃₎, and the group number of the former partial pattern A is set to be smaller than the group number of the latter partial pattern F in the steps S72 to S79.

Thus, control circuit 5 overwrites the data of the zeroth Group₍₀₎ to the fourth Group₍₄₎ with the data obtained after changing the overlapping order (see the upper part of FIG. 6(c)) of the partial patterns C to E, B, A, F, and H which represent the entire pattern M in a concave shape, thereby updating the data (step S82). The layers 50B1, 50Ye, 50B1, 50Gr, and 50YG shown in the lower part of FIG. 6(c) are respectively linked to the outlines of the partial patterns C to E, B, A, F, and H, respectively.

Accordingly, the control circuit 5 stores the group number of the partial patterns C to E, B, A, F, and H in the RAM 7 as the order of the layers 50B1, 50Ye, 50B1, 50Gr, and 50YG which represent the entire pattern M in a concave shape (step S82). The order of the layers 50B1 to 50YG corresponds to the order of sheets to be superimposed on the base sheet. An order “0” is assigned to a base layer 50 corresponding to the base sheet; an order “1” is assigned to a first layer 50 corresponding to the first sheet; an order “2” is assigned to a second layer 50 corresponding to the second sheet; an order “3” is assigned to a third layer 50 corresponding to the third sheet; and an order “4” is assigned to a fourth layer 50 corresponding to the fourth sheet. The following description is made assuming that the layer 50B1 corresponds to the base layer; the layer 50Ye corresponds to the first layer; the layer 50B1 corresponds to the second layer; the layer 50Gr corresponds to the third layer; and the layer 50YG corresponds to the fourth layer.

After that, the control circuit 5 returns to step S16 of FIG. 9 to cause the display 3 to display a pattern display screen (not shown) to determine whether the grouped partial patterns are defective or non-defective. On the pattern display screen, for example, the partial patterns are displayed in the corresponding color of the layers 50B1 to 50YG for each group so as to visually observe the partial patterns C to E as one group (see FIG. 6(b)). The user operates the mouse 4b or the like to input a signal for determining whether grouping of partial patterns is defective or non-defective while viewing the pattern display screen. The control circuit 5 accepts the input signal from the mouse 4b or the like, and determines the group and order of the partial patterns set in the steps S14 and S15.

Further, the control circuit 5 performs an allocation process for creating and allocating cutting-plane line data for each of the layers 50B1 to 50YG according to the determined order. First, in step S17, the control circuit 5 resets the counter k corresponding to the overlapping order of the layers 50B1 to 50YG to “0” (k=0), and performs the allocation process from the base layer 50B1 which is located at the bottom. Further, the control circuit 5 sets Cut-Outline to Null. Cut-Outline is information representing a set of vector data on the outline for creating the cutting-plane line data. Thus, since the counter k indicates “0” at the time (YES in step S18) and Cut-Outline is set to Null, the cutting-plane line data for the outline is not created for the base layer 50B1 corresponding to the order “0” (step S19).

On the other hand, the control circuit 5 creates the cutting-plane line data including the vertex P₀ as the cutting start point and the cutting end point P₄ based on the coordinate data of the vertices P₀ to P4 of the border 41 set in the step S12 (see step S20 and FIG. 6(d)).

Further, the control circuit 5 sets coordinate data of a notch mark 42 indicating the orientation of the base sheet 20 based on the coordinate data of the border 41 (step S21). The notch mark 42 is, for example, a circular hole having a size through which a string or the like can penetrate through as shown in FIG. 6(d), and is preliminarily set so as to be disposed at a coordinate position at an upper left corner of the base layer 50B1. The control circuit 5 creates cutting-plane line data for cutting out the notch mark 42 based on the coordinate data of the disposed notch mark 42 (step S22). The created cutting-plane line data includes feed data and a number of pieces of coordinate data corresponding to a large number of points on the circumference of the notch mark 42.

Thus, the control circuit 5 stores the cutting-plane line data of the border 41 and the notch mark 42 created for the base layer 50B1 in the RAM 7 in such a way that the cutting-plane line data is linked to the order “0” (step S23). Further, the control circuit 5 sets Cut-Outline to the vector data of the outlines of the partial patterns C to E of the Group₍₀₎ having the group number corresponding to the value (=0) of the counter k at the time (step S24). After that, the control circuit 5 increments the counter k by 1 (step S25) and executes the steps S18 to S25 for the first layer 50Ye corresponding to the order “1”.

Specifically, when the counter k indicates “1” (YES in step S18), the control circuit 5 creates cutting-plane line data for the partial patterns C to E of the Group₍₀₎ set to Cut-Outline for the first layer 50Ye (step S19). At this time, cutting-plane line data of three outlines having the vertex P₀ as the cutting start point and the cutting end point Pₙ is created based on the coordinate data of the points P₀ to Pₙ of the partial pattern C, the points P₀ to Pₙ of the partial pattern D, and the points P₀ to Pₙ of the partial pattern E (see FIG. 5A and FIG. 6(d)). Further, the control circuit 5 creates the cutting-plane line data of the border 41 and the notch mark 42 for the first layer 50Ye, in the same manner as that for the base layer 50B1 (steps S20 to S22). Thus, the control circuit 5 stores the created cutting-plane line data of each of the outlines of the three partial patterns C to E, the border 41, and the notch mark 42 for the first layer 50Ye in the RAM 7 in such a way that the cutting-plane line data is linked to the order “1” (step S23).

Further, the control circuit 5 combines the outlines of the partial patterns C to E set to Cut-Outline with the outline of the partial pattern B of the Group₍₁₎ having the group number corresponding to the value (=1) of the counter k (step S24). At this time, the outlines of the partial patterns C to E among the partial patterns C to E and B do not correspond to Cut-Outline. In other words, the outlines of the partial patterns C to E are included in the outline of the partial pattern B and are cut out as the inside of the border of the partial pattern B in the first mode. Accordingly, the control circuit 5 sets (updates) Cut-Outline as the outline of the partial pattern B. Further, the control circuit 5 increments the counter k by 1 (step S25), and executes the steps S18 to S25 for the second layer 50B1 corresponding to the order “2”.

In this case, the counter k indicates “2” (YES in step S18), the control circuit 5 creates cutting-plane line data of the outline including the vertex P₀ as the cutting start point and the cutting end point P₁₀ based on the coordinate data of the vertices P₀ to P₁₀ of the partial pattern B set to Cut-Outline for the second layer 50B1 (see FIGS. 5A and 6(d)). Further, the control circuit 5 creates the cutting-plane line data of the border 41 and the notch mark 42 for the second layer 50B1 (steps S20 to S22). Thus, the control circuit 5 stores the created cutting-plane line data of each of the outline of the partial pattern B, the border 41, and the notch mark 42 for the second layer 50B1 in the RAM 7 in such a way that the cutting-plane line data is linked to the order “2” (step S23).

Next, the control circuit 5 combines the outline of the partial pattern B set to Cut-Outline with the outline of the partial pattern A of the Group₍₂₎ having the group number corresponding to the value (=2) of the counter k (step S24). Since the outline of the partial pattern B is included in the outline of the partial pattern A, the control circuit 5 updates Cut-Outline as the outline of the partial pattern A. Further, the control circuit 5 increments the counter k by 1 (step S25), and executes the steps S18 to S25 for the third layer 50Gr having the order “3”.

In this case, the counter k indicates “3” (YES in step S18), and the control circuit 5 creates cutting-plane line data of the outline including the vertex P₀ as the cutting start point and the cutting end point P₁₀ based on the coordinate data of the vertices P₀ to P₁₀ of the partial pattern A set to Cut-Outline for the third layer 50Gr (see FIG. 4B and FIG. 5A). Further, the control circuit 5 creates the cutting-plane line data of the border 41 and the notch mark 42 for the third layer 50Gr (steps S20 to S22). Thus, the control circuit 5 stores the created cutting-plane line data of the outline of the partial pattern A, the border 41, and the notch mark 42 for the third layer 50Gr in the RAM 7 in such a way that the cutting-plane line data is linked to the order “3” (step S23).

Further, the control circuit 5 combines the outline of the partial pattern A set to Cut-Outline with the outline of the partial pattern F of the Group₍₃₎ having the group number corresponding to the value (=3) of the counter k (step S24). In this case, there is no inclusion relation between the partial pattern A and the partial pattern F, and the control circuit 5 updates Cut-Outline as a set of vector data representing the outline of one partial pattern G. Further, the control circuit 5 increments the counter k by 1 (step S25), and executes the steps S18 to S25 for the four layer 50YG having the order “4”.

In this case, the counter k indicates 4 (YES in step S18), and the control circuit 5 creates cutting-plane line data of the outline including the vertex P₀ as the cutting start point and the cutting end point P₁₈ based on the coordinate data of the varices P₀ to P₁₈ of the partial pattern G set to Cut-Outline for the fourth layer 50YG (see FIG. 5A and FIG. 6(d)). Further, the control circuit 5 creates the cutting-plane line data of the border 41 and the notch mark 42 for the fourth layer 50YG (step S20 to S22). Thus, the control circuit 5 stores the created cutting-plane line data of each of the outline of the partial pattern G, the border 41, and the notch mark 42 for the fourth layer 50YG in the RAM 7 in such a way that the cutting-plane line data is linked to the order “4” (step S23).

Since the outline of the partial pattern H linked to the fourth layer 50YG is set as the border 41, setting of Cut-Outline is not updated in the subsequent step S24. When the counter k is incremented by 1 (step S25), the control circuit 5 determines that the value “5” of the counter k reaches the group total number N (i.e., the number of layers N) in step S18 (NO). In this case, the control circuit 5 adds the end code, data for display, and the like to the cutting-plane line data linked to the layers 50B1 to 50YG corresponding to the orders “0” to “4”, respectively, and then terminates the first cutting data creation process (end).

Thus, the data for display of the created first cutting data uses the layers 50B1 to 50YG, which enables display of the entire pattern M in a concave shape. Specifically, as shown in FIG. 6(e), the following image layers are generated. That is, the yellow image layer 50Ye obtained by cutting out the inside of the outlines of the three partial patterns C to E for the first layer 50Ye; the black image layer 50B1 obtained by cutting out the inside of the outline of the partial pattern B for the second layer 50B1; the green image layer 50Gr obtained by cutting out the inside of the outline of the partial pattern A for the third layer 50Gr; and the yellow-green image layer 50YG obtained by cutting out the inside of the outline of the partial pattern G for the fourth layer 50YG. The yellow image layer 50Ye is superimposed on the black image layer 50B1 as the base layer 50B1; the black image layer 50B1 is superimposed on the image layer 50Ye; the green image layer 50Gr is superimposed on the image layer 50B1; and the yellow-green image layer 50YG is superimposed on the image layer 50Gr (see FIG. 3B). As a result, the internal part of the partial pattern G with respect to the top yellow-green image layer 50YG is represented in a plurality of colors by the image layers 50B1 to 50Gr which are formed on the lower side, and thus the entire pattern M is displayed in a concave shape.

The first cutting data created by the cutting data creation device 1 is received by the cutting device 11 and the cutting operation can be executed based on the first cutting data. In this case, the cutting device 11 can perform the cutting operation for the black sheet 20B1, the yellow sheet 20Ye, the black sheet 20B1, the green sheet 20Gr, and the yellow-green sheet 20YG according to the order data indicating “0”, “1”, “2”, “3”, and “4” of the first cutting data. Thus, as shown in FIG. 3B, when the sheets 20B1 to 20YG are superimposed according to the cutting order using the notch mark 42 as a mark, the decoration 51 representing the entire pattern M of “flower” formed of a combination of the plurality of partial patterns H and A to G in a concave shape can be prepared.

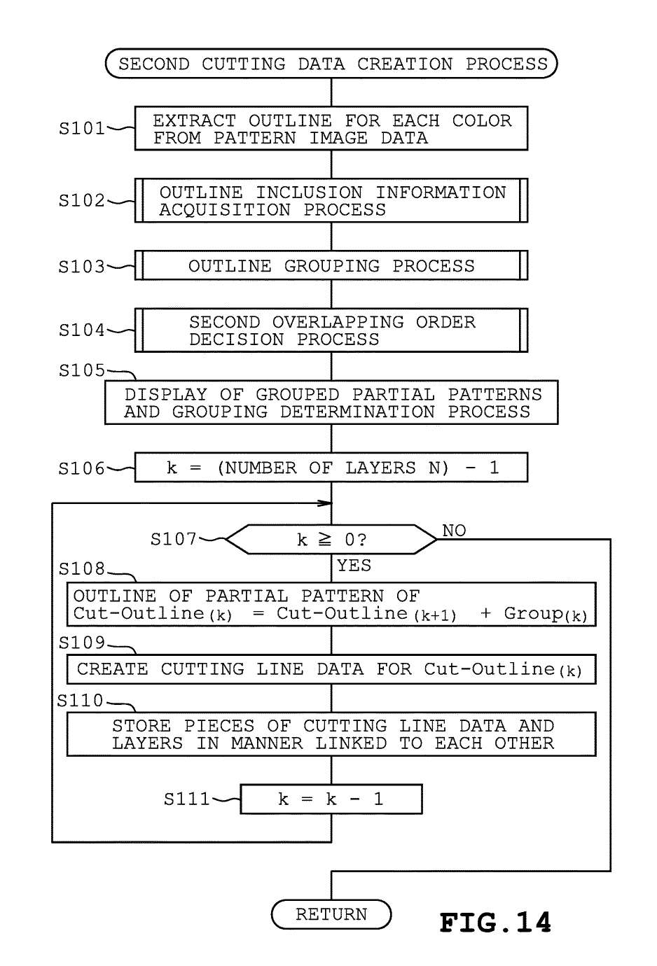

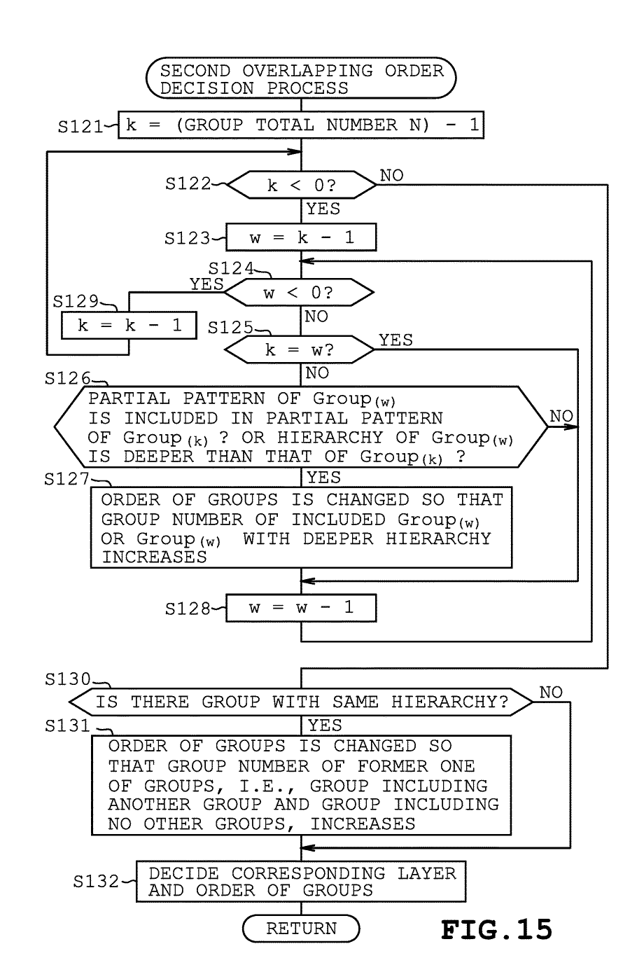

Next, a second cutting data creation process when the second mode is selected (NO in the step S5) will be described with reference to FIGS. 14 and 15. In steps S101, S102, and S103 of the second cutting data creation process shown in FIG. 14, processes similar to steps S11, S13, and

S14 of the first cutting data creation process are executed, and thus the differences between the first cutting data creation process and the second cutting data creation process will be mainly described.

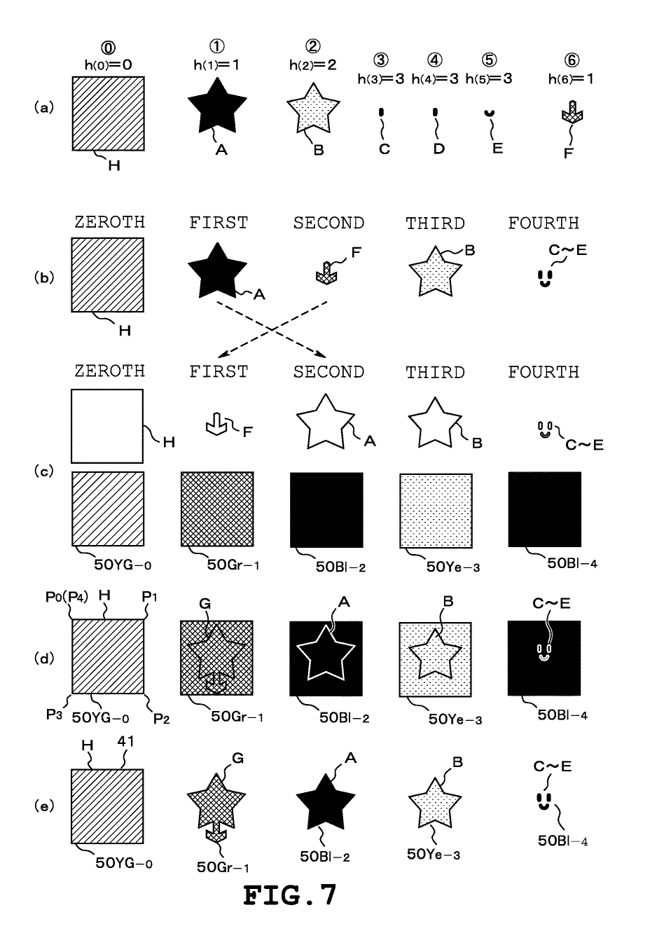

Specifically, in the second cutting data creation process, like in the first cutting data creation process, the outlines of “a peripheral area”, “trimming part”, . . . and “leaves and a stalk” from the pattern image data are extracted and identified as the partial patterns H, A, . . . and F (see step S101 and FIG. 7(a)). Next, the control circuit 5 executes the inclusion information acquisition process (steps S31 to S41 in FIG. 10) in step S102. As a result, like in the first cutting data creation process, hierarchy depths 0, 1, . . . , and 1 (h₍₀₎ to h₍₆₎ in FIG. 7(a)) of the partial patterns H, A, . . . , and F and the maximum value (Maxh=3) of the hierarchy depths are acquired.

Further, the control circuit 5 executes the grouping process in step S103 (steps S51 to S68 in FIGS. 11 and 12) to group the partial patterns H, A, . . . , and F as the zeroth, first, . . . , and fourth Group₍₄₎ as shown in FIG. 7(b). Then, the control circuit 5 executes the second overlapping order decision process in step S104.

In the second overlapping order decision process shown in FIG. 15, the order of groups is changed so as to correspond to the overlapping order of the plurality of sheets 20 representing the entire pattern M with a convex shape. Specifically, in step S121, the control circuit 5 decrements the counter k by 1 from the number of layers N (k=N−1), and sets the value of the counter k to 4 (NO in step S122). Further, in step S123, the control circuit 5 decrements the target counter w by 1 (w=k−1) and sets the value of the target counter w to 3 (NO in step S124). Specifically, in the second mode, as for the inclusion relation and the hierarchy depth relation between the partial patterns of the zeroth Group₍₀₎ to the fourth Group₍₄₎, the third Group₍₃₎ and the fourth Group₍₄₎ indicated by the values “3” and “4” of the counters w and k are processed in an order from the group with the largest group number. When the judgment result in step S124 indicates NO, the process shifts to step S125, and when the judgment result in step S124 indicates YES, the process shifts to step S129. In step S125, the control circuit 5 judges whether or not the value of the counter k is equal to the value of the target counter w. When the value of the counter k is equal to the value of the target counter w, the process shifts to step S128. When the value of the counter k is not equal to the value of the target counter w, the process shifts to step S126.

At this time, the control circuit 5 discriminates that the partial pattern B of the third Group₍₃₎ is not included in the partial patterns C to E of the fourth Group₍₄₎. The depth h₍₁₎ of the hierarchy of the partial pattern B is 2 which is smaller than the depth (h₍₃₎ to h₍₅₎=3) of the hierarchy of the partial patterns C to E. Accordingly, the control circuit 5 judges that the partial patterns C to E are convex forward with respect to the partial pattern B (NO in step S126). Accordingly, the order of groups of the partial pattern B of the third Group₍₃₎ and the partial patterns C to E of the fourth Group₍₄₎ is not changed in step S126.

Further, the control circuit 5 decrements the value of the target counter w by 1 while the value of the counter k remains at 4 (step S128), and sequentially discriminates the inclusion relation and the hierarchy depth relation between the partial patterns C to E of the fourth Group₍₄₎ and the partial patterns F, A, and H of the second Group₍₂₎, the first Group₍₁₎, and zeroth Group₍₀₎ corresponding to the value of the counter k (steps S124 to S128). Also in this case, the partial patterns F, A, and H of the second Group₍₂₎, the first Group₍₁₎, and the zeroth Group₍₀₎ are not included in the partial patterns C to E of the fourth Group₍₄₎, and the hierarchy of the partial patterns F, A, and H of the second Group₍₂₎, the first Group₍₁₎, and the zeroth Group₍₀₎ is shallower than the hierarchy of the partial patterns C to E (NO in step S126). Accordingly, even when the target counter w indicates a negative value (YES in step S124), the order of groups shown in FIG. 7(b) is not changed.

Further, the control circuit 5 decrements the value of the counter k one by one (k=3, 2, 1, step S129) as described above, and repeatedly executes steps S124 to S128 for the partial patterns of the third Group₍₃₎ to the first Group₍₁₎, thereby sequentially discriminating the inclusion relation and the hierarchy depth relation between the partial patterns of the second Group₍₂₎ to the zeroth Group₍₀₎. As a result, even when the counter k indicates a negative value (YES in step S122), smaller group numbers are assigned to the groups in the order from the highest hierarchy in the grouping process in the step S103, and thus the order of groups is not changed.

Further, when the control circuit 5 determines that the first Group₍₁₎ and second Group₍₂₎ having the same hierarchy depth as that of the partial patterns A and F among the groups are present in step S130, the order of groups is changes in such a way that the group number of the partial pattern A including another partial pattern B is larger than the group number of the partial pattern F which does not include another partial pattern B (step S131). Specifically, as shown in FIG. 7(c), the order of groups is changed in such a way that the partial pattern F is set to the first Group₍₁₎ and the partial pattern A is set to the second Group₍₂₎ and another partial pattern B is convex forward with respect to the partial pattern A.

Thus, the control circuit 5 overwrites the data of the zeroth Group₍₀₎ to the fourth Group₍₄₎ with the data obtained after changing the overlapping order (see the upper part of FIG. 7(c)) of the partial patterns H, F, A, B, and C to E representing the entire pattern M in a convex shape, thereby updating the data (step S132). Further, the control circuit 5 stores the group numbers of the partial patterns H, F, A, B, and C to E in the RAM 7 as the order of the layers 50YG, 50Gr, 50B1, 50Ye, and 50B1 (step S132). The following description is made assuming that the layer 50YG corresponds to the base layer; the layer 50Gr corresponds to the first layer; the layer 50B1 corresponds to the second layer; the layer 50Ye corresponds to the third layer; the layer 50B1 corresponds to the fourth layer.

After that, the control circuit 5 returns to step S105 shown in FIG. 14, and displays, on the pattern display screen of the display 3, the grouped partial patterns in the corresponding colors of the layers 50YG to 50B1. The user operates the mouse 4b or the like to input a signal for determining whether grouping of partial patterns is defective or non-defective while viewing the pattern display screen. The control circuit 5 accepts the input signal from the mouse 4b or the like, and determines the group and order of the partial patterns set in the steps S103 and S104.

The control circuit 5 performs an allocation process for creating and allocating cutting-plane line data for each of the layers 50YG to 50B1 according to the determined order. In this case, in the initial setting (step S106), the control circuit 5 decrements the counter k by 1 from the number of layers N corresponding to the group total number N (k=N−1), and sets the value of the counter k to “4” (k=4). Thus, in the second mode, the allocation process is executed in an order from the top (right side of FIG. 7(d)) fourth layer 50B1.

Next, for the fourth layer 50B1 indicated by the counter k of “4” (YES in step S107), the control circuit 5 sets Cut-Outline₍ₖ₎ for creating cutting-plane line data (step S108). In this step S108, the outline of the partial pattern of the Group₍ₖ₎ identified by the counter k is combined with the outline of the partial pattern of a layer₍ₖ₊₁₎ superimposed on the layer. Since there is no layer superimposed on the fourth layer 50B1, the outlines of the partial patterns C to E of the fourth Group₍₄₎ are set as Cut-Outline₍ₖ₎. Thus, the control circuit 5 creates the cutting-plane line data of three outlines based on the coordinate data of the vertices P₀ to Pₙ of the partial patterns C to E set as Cut-Outline₍ₖ₎ (see step S109, FIG. 5B, and FIG. 7(d)). The control circuit 5 stores the cutting-plane line data of the outlines of the partial patterns C to E created for the fourth layer 50B1 in the RAM 7 in such a manner that the cutting-plane line data is linked to the order “4” (step S110). Further, the control circuit 5 decrements the counter k by 1 (step S111), and executes the steps S107 to S111 for the third layer 50Ye.

In this case, since the counter k indicates “3” (YES in step S107), the control circuit 5 combines the outline of the partial pattern B of the third Group₍₃₎ with the outlines of the partial patterns C to E as Cut-Outline₍ₖ₊₁₎ (step S108). When Cut-Outline₍ₖ₊₁₎ is included in the outline of the partial pattern B, like the outlines of the partial patterns C to E, the Cut-Outline₍ₖ₊₁₎ does not correspond to Cut-Outline₍ₖ₎. Accordingly, the control circuit 5 sets the outline of the partial pattern B as Cut-Outline₍ₖ₎.

The control circuit 5 creates the cutting-plane line data of the outline based on the coordinate data of the vertices P₀ to P₁₈ of the partial pattern B set as Cut-Outline₍ₖ₎ (see step S109, FIG. 5B, and FIG. 7(d)). Thus, the control circuit 5 stores the cutting-plane line data created for the third layer 50Ye in the RAM 7 in such a way that the cutting-plane line data is linked to the order “3” (step S110). Further, the control circuit 5 decrements the counter k by 1 (step S111), and executes the steps S107 to S111 for the second layer 50B1.

When the counter k indicates “2” (YES in step S107), the control circuit 5 combines the outline of the partial pattern A of the second Group₍₂₎ with the outline of the partial pattern B of the Cut-Outline₍ₖ₊₁₎ (step S108). Since the outline of the partial pattern B is included in the outline of the partial pattern A, the control circuit 5 updates the outline of the partial pattern A as Cut-Outline₍ₖ₎. The control circuit 5 creates the cutting-plane line data of the outline based on the coordinate data of the vertices P₀ to P₁₀ of the partial pattern A (see step S109, FIG. 5B, and FIG. 7(d)). Thus, the control circuit 5 stores the cutting-plane line data created for the second layer 50B1 in the RAM 7 in such a way that the cutting-plane line data is linked to the order “2” (step S110). Further, the control circuit 5 decrements the counter k by 1 (step S111), and executes the steps S107 to S111 for the first layer 50Gr.

When the counter k indicates 1 (YES in step S107), the control circuit 5 combines the outline of the partial pattern F of the first Group₍₁₎ with the outline of the partial pattern A as Cut-Outline₍ₖ₊₁₎ (step S108). By the combination, the control circuit 5 sets Cut-Outline₍ₖ₎ as the outline of one partial pattern G. The control circuit 5 creates the cutting-plane line data of the outline based on the coordinate data of the vertices P₀ to P₁₈ of the partial pattern G set as Cut-Outline₍ₖ₎ (see step S109, FIG. 5B, and FIG. 7(d)). Thus, the control circuit stores the created cutting-plane line data for the first layer 50Ye in the RAM 7 in such a way that the cutting-plane line data is linked to the order “1” (step S110). Further, the control circuit 5 decrements the counter k by 1 (step S111), and executes the steps S107 to S111 for the base layer 50YG.

When the counter k indicates 0 (YES in step S107), the control circuit 5 combines the outline of the partial pattern H of the zeroth Group₍₀₎ with the outline of the partial pattern G as Cut-Outline₍ₖ₊₁₎ (step S108). Since the outline of the partial pattern G is included in the outline of the partial pattern H, the control circuit 5 updates the outline of the partial pattern H as Cut-Outline₍ₖ₎. The control circuit 5 creates cutting-plane line data of the border 41 based on the coordinate data of vertices P₀ to P₄ of the partial pattern H (see step S109, FIG. 5B, and FIG. 7(d)). Thus, the control circuit 5 stores the cutting-plane line data created for the base layer 50YG in the RAM 7 in such a way that the cutting-plane line data is linked to the order “0” (step S110).

After that, the control circuit 5 decrements the counter k by 1 (step S111), and determines that the process for all the layers 50YG to 50B1 is completed (NO in step S107). In this case, the control circuit 5 adds the end code, data for display, and the like to the cutting-plane line data corresponding to the layer 50YG to 50B1 of the orders “0” to “4”, respectively, and then terminates the second cutting data creation process (end).

Thus, the created data for display of the second cutting data uses the layers 50YG to 50B1, which enables display of the entire pattern M in a convex shape. Specifically, as shown in FIG. 7(e), the following layers are generated. That is, the green image layer 50Gr including the outline of the partial pattern G for first layer 50Gr; the black image layer 50B1 including the outline of the partial pattern A for the second layer 50B1; the yellow image layer 50Ye including the outline of the partial pattern B for the third layer 50Gr; and the black image layer 50B1 including the outlines of the partial patterns C to E for the fourth layer 50B1. Further, the green image layer 50Gr is superimposed on the yellow-green image layer 50YG; the black image layer 50B1 is superimposed on the image layer 50Gr; the yellow image layer 50Ye is superimposed on the image layer 50B1; and the black image layer 50B1 is superimposed on the image layer 50Ye (see FIG. 3C). As a result, the partial patterns G, A, B, and C to E are represented in a plurality of colors by the higher image layers 50Gr, 50B1, 50Ye, and 50B1 with respect to the bottom yellow-green image layer 50YG, so that the entire pattern M is formed in a convex shape.

Further, the second cutting data created by the cutting data creation device 1 is received by the cutting device 11, thereby making it possible to execute the cutting operation based on the second cutting data. In this case, the cutting device 11 performs the cutting operation for the yellow-green sheet 20YG, the green sheet 20Gr, the black sheet 20B1, the yellow sheet 20Ye, and the black sheet 20B1 according to the order data of “0”, “1”, “2”, “3”, and “4” of the second cutting data. Thus, as shown in FIG. 3C, when the sheets 20Gr to 20B1 are superimposed on the base sheet 20YG according to the cutting order, the decoration 52 representing the entire pattern of “flower” formed as a combination of the plurality of partial patterns H and A to G in a convex shape can be prepared (see FIG. 3A). As shown in FIG. 3C, the cutting-plane line data for the notch mark 42 may be created for the second cutting data.

As described above, by executing the cutting data creation program, the overlapping order of the plurality of partial patterns H and A to G is decided through the steps (steps S35, S65, S75, S125 and the like) of discriminating whether or not one partial pattern is included in another partial pattern. Accordingly, superimposing the plurality of sheets 20 makes it possible to create the cutting data capable of representing the entire pattern M in a desired concave shape or convex shape based on the inclusion relation between the partial patterns.

In particular, in this exemplary embodiment, steps (steps S14, S103, and the like) of allocating an order of the groups to specific partial patterns belonging to one group is executed. Accordingly, in the step, an order for each of the partial patterns A, B, F, and H is substantially allocated to a group to which only one of the partial patterns A, B, F, and H belongs, while an order for each group is allocated to a group to which a plurality of partial patterns C to E (specific partial patterns) belongs. Thus, the plurality of partial patterns C to E is formed on one sheet 20, and the cutting data capable of reducing the number of sheets used as the sheets 20 can be automatically created.

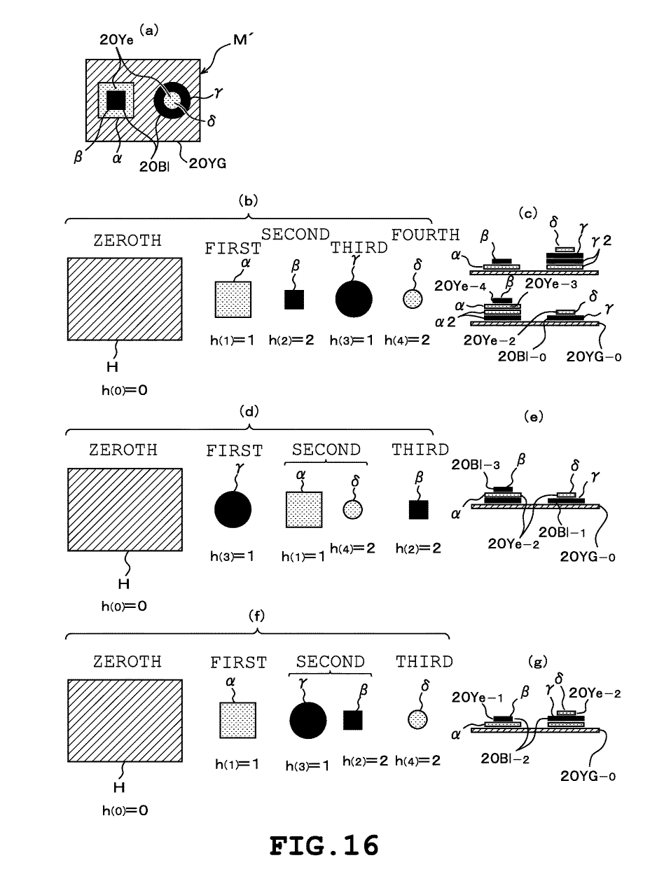

In this regard, the conditions for grouping specific partial patterns as one group are not limited to steps S64 to S66 described above with reference to FIG. 12. For example, even when the partial patterns have different hierarchy depths (NO in step S66), the partial patterns may be grouped as one group. This grouping will be described below with reference to FIG. 16.

An entire pattern M′ shown in FIG. 16A has a convex shape in which two large and small partial patterns α and β forming a square and two large and small partial patterns γ and δ forming a circular shape are respectively arranged on the right and left sides with respect to the base sheet 20YG (see the side view of FIGS. 16(c), 16(e), and 16(g)). Further, the square partial pattern β and the circular partial pattern γ are formed using the black sheet 20B1, and the square partial pattern a and the circular partial pattern δ are formed using the yellow sheet 20Ye.

FIG. 16(b) shows the partial patterns α, β, γ, and δ and the base sheet 20YG (the partial pattern H the peripheral area). When the grouping is not present, as shown in FIG. 16(c), the orders “1” to “4” for each of the partial patterns α, β, γ, and δ are allocated. Accordingly, four sheets 20 which corresponds to the number of the partial patterns α, β, γ, and δ, and the sheets 20 are required, are wastefully cut for representing the entire pattern M′ (see parts α2 and γ2 in FIG. 16(c)).

On the other hand, as shown in FIGS. 16(d) and 16(f), steps S64 to S70 of grouping the partial pattern a and the partial pattern δ, or the partial pattern β and the partial pattern γ, as one group is executed, to thereby reduce the number of sheets used as the sheets 20 and prevents the sheets 20 from being wastefully cut (see FIGS. 16(e) and 16(g)).

Specifically, the partial pattern a and the partial pattern δ shown in FIG. 16(d) do not have the same color and there is no inclusion relation between the partial patterns (YES in steps S64 and S65). In this case, when the control circuit 5 determines that the depth “1” of the hierarchy of the partial pattern a is different from the depth “2” of the hierarchy of the partial pattern δ (see h₍₁₎ and h₍₄₎ in FIG. 16(d)) (NO in step S66), the control circuit 5 judges whether or not the outlines of the partial patterns H and γ in the hierarchy higher than that of the partial patterns α and δ are grouped (step S69). In this case, when the control circuit 5 determines that the outlines of the partial patterns H and γ are not grouped (YES), the control circuit 5 groups the partial pattern α and the partial pattern δ as one group (step S67).

Similarly, the partial pattern β and the partial pattern γ shown in FIG. 16(f) do not have the same color and there is no inclusion relation between the partial patterns (YES in steps S64 and S65). Further, when it is determined that the depth “1” of the hierarchy of the partial pattern β is different from the depth “2” of the hierarchy of the partial pattern γ (see h₍₂₎ and h₍₃₎ in FIG. 16(f)) and the outlines of the partial patterns H and a of higher hierarchies are not grouped (YES in step S69), the partial pattern β and the partial pattern γ are grouped as one group (step S67).

Further, even when the control circuit 5 determines that the outlines of the partial patterns of higher hierarchies are grouped in the step S69 (NO) and the partial patterns belonging to the groups of the higher hierarchies do not include the partial patterns belonging to the Group₍ₖ₎ (YES in step S70), the control circuit 5 groups the partial patterns (step S67). Specifically, the grouping of the partial patterns α and δ shown in FIG. 16(d) is incompatible with the grouping of the partial patterns β and γ shown in FIG. 16(f) (see FIGS. 16(e) and 16(g)). Accordingly, when there is a possibility that the inclusion relation between the partial patterns in both groups may be established, that is, when there is a possibility that the grouping of partial patterns α and δ and the grouping of the partial patterns β and γ for which the hierarchy depth and color information are discriminated may be established, the grouping is not carried out (NO in step S70). When the inclusion relation is not established, the grouping can be carried out (YES in step S70).

As described above, the decorations 51 and 52 are not limited to the entire patterns M and M′. For example, a decoration representing the entire pattern M′ shown in FIG. 16A in a concave shape may be used. Also in this case, the number of sheets used as the sheets 20 necessary for preparing the decoration by grouping as described above can be reduced.

As described above, the cutting data creation method according to this exemplary embodiment includes: a discrimination step (steps S35, S65, S75, and S125) of discriminating, for each partial pattern, whether or not one of a plurality of partial patterns is included in another one of the plurality of partial patterns; an order decision step (steps S14, S15, S103, and S104) of deciding an overlapping order of the plurality of partial patterns based on the discrimination result; an outline setting step (steps S23 and S110) of setting an outline of each of the partial patterns for each sheet 20 corresponding to the order; and a cutting data creation step (steps S19, S23, S109, and S110) of creating cutting data based on the outline of each of the partial patterns set for each sheet 20.

According to this method, in the order decision step, the overlapping order of the plurality of partial patterns is decided based on the discrimination result as to the inclusion of the partial patterns, and in the outline setting step, the outline of each of the partial patterns is set for each sheet 20 corresponding to the order. Thus, cutting data for cutting the outline of each partial pattern set according to the result of the discrimination as to whether one of a plurality of partial patterns is included in another one of the plurality of partial patterns for the plurality of sheets 20 can be created. Accordingly, the plurality of sheets 20 is cut based on the created cutting data, and when the sheets 20 are superimposed in order, the decorations 51 and 52 representing the entire pattern formed of a combination of the plurality of partial patterns in the overlapping order based on the result of the discrimination as to whether one of a plurality of partial patterns is included in another one of the plurality of partial patterns can be prepared.

Furthermore, the control circuit 5 of the cutting data creation device 1 includes: a discrimination unit that discriminates whether or not one of a plurality of partial patterns is included in another one of the plurality of partial patterns for each of the partial patterns; an order decision unit that decides an overlapping order of the plurality of partial patterns based on the discrimination result; an outline setting unit that sets, for each layer 50 corresponding to the order decided by the order decision unit, an outline of each of the partial patterns for the plurality of layers 50 corresponding to the plurality of sheets 20; and a cutting data creation unit that creates cutting data corresponding to the plurality of sheets 20 based on the outline of each of the partial patterns set for each layer 50 by the outline setting unit.

In this configuration, the order decision unit decides the overlapping order of the plurality of partial patterns based on the result of the discrimination as to whether one of a plurality of partial patterns is included in another one of the plurality of partial patterns, and the outline setting unit sets the outline of each of the partial patterns for each layer 50 corresponding to the order. Thus, cutting data for cutting the outline of each of the partial patters set according to the result of the discrimination as to whether one of a plurality of partial patterns is included in another one of the plurality of partial patterns can be created for the plurality of sheets 20. Accordingly, the plurality of sheets 20 is cut based on the created cutting data and the sheets 20 are superimposed in order, thereby making it possible to prepare the decorations 51 and 52 representing the entire pattern formed of a combination of the plurality of partial patterns in the overlapping order based on the result of the discrimination as to whether one of a plurality of partial patterns is included in another one of the plurality of partial patterns.

The control circuit 5 and the image scanner 10 are configured as a color information acquisition unit that acquires color information about the plurality of partial patterns for each of the partial patterns. The cutting data creation method further includes: a color information acquisition step (step S3) of acquiring, by the color information acquisition unit, color information about the partial patterns; and a grouping step (steps S14 and S103; the control circuit 5 serving as a grouping unit) of grouping, as one group, specific partial patterns from the plurality of partial patterns based on the color information about the partial patterns acquired in the color information acquisition step and the result of the decimation as to whether one of a plurality of partial patterns is included in another one of the plurality of partial patterns in the discrimination step. The order decision step (order decision unit) includes allocating an order for each group to the specific partial patterns belonging to the group among the plurality of partial patterns, and allocating an order for each partial pattern to partial patterns other than the specific partial patterns.

According to the configuration, the plurality of partial patterns can be grouped as one group according to the color information and the result of the discrimination as to whether one of a plurality of partial patterns is included in another one of the plurality of partial patterns. When the plurality of partial patterns is grouped as one group, the order of the sheets 20 corresponding to each group is allocated for each group, so that the number of sheets used as the sheets 20 necessary for preparing the decorations 51 and 52 can be reduced.

The cutting data creation method includes a selection step (step S5) of selecting one of: a first mode in which the partial patterns are concave backward with respect to the top sheet 20 when the plurality of sheets 20 (layers 50) is superimposed and the entire pattern has a concave shape; and a second mode in which the partial patterns are convex forward with respect to the bottom sheet 20 when the plurality of sheets 20 is superimposed and the entire pattern has a convex shape. The control circuit 5, the display 3, and the input unit 4 are configured as a selection unit that selects one of the first mode and the second mode.

According to this configuration, one of the first mode and the second mode is selected in the selection step (selection unit), thereby making it possible to arbitrarily select one of the convex shape and the concave shape of the entire pattern M of the decorations 51 and 52 and creating cutting data with which the decorations 51 and 52 are obtained in a user's desired form.

The order decision step includes deciding an overlapping order of the plurality of partial patterns according to the mode selected in the selection step. According to this method, when the first mode is selected, the cutting data in which the overlapping order of the partial patterns is set to represent the entire pattern M in a concave shape can be created. When the second mode is selected, the cutting data in which the overlapping order of the partial patterns is set to represent the entire pattern M in a convex shape can be created.

The cutting data creation method includes: a display step (step S16; the control circuit 5 setting as a display unit) of displaying, on a display, the specific partial patterns grouped in the grouping step; and an accepting step (step S16) of accepting an input to determine whether the grouped specific partial patterns displayed on the display are defective or non-defective. The control circuit 5 and the input unit 4 are configured as an accepting unit that accepts the input.

According to this configuration, the group of the specific partial patterns displayed on the display can be visually observed, and whether the grouping is defective or non-defective can be determined in the accepting step (accepting unit), thereby making it possible to create the cutting data with which the decorations 51 and 52 in a user's desired form are obtained.

### Second Exemplary Embodiment

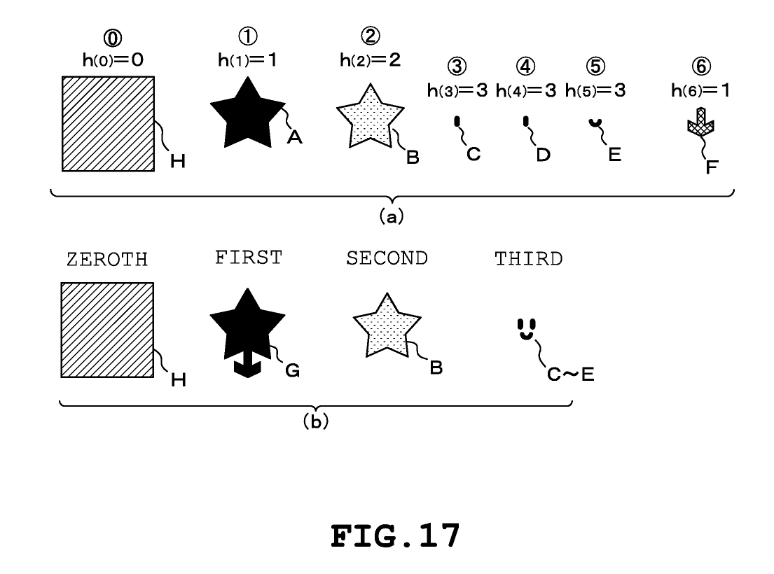

FIGS. 17 to 19 each show a second exemplary embodiment. The components of the second exemplary embodiment that are the same as those of the first exemplary embodiment are denoted by the same reference numerals, and differences between the first exemplary embodiment and the second exemplary embodiment will be described. FIG. 17(a) shows the partial patterns H, A, . . . , and F identified in the step S11. In the second exemplary embodiment, grouping of the partial patterns H, A, . . . , and F as shown in FIG. 17(b) is carried out based on the color information and the number of sheets 20 set by the user.

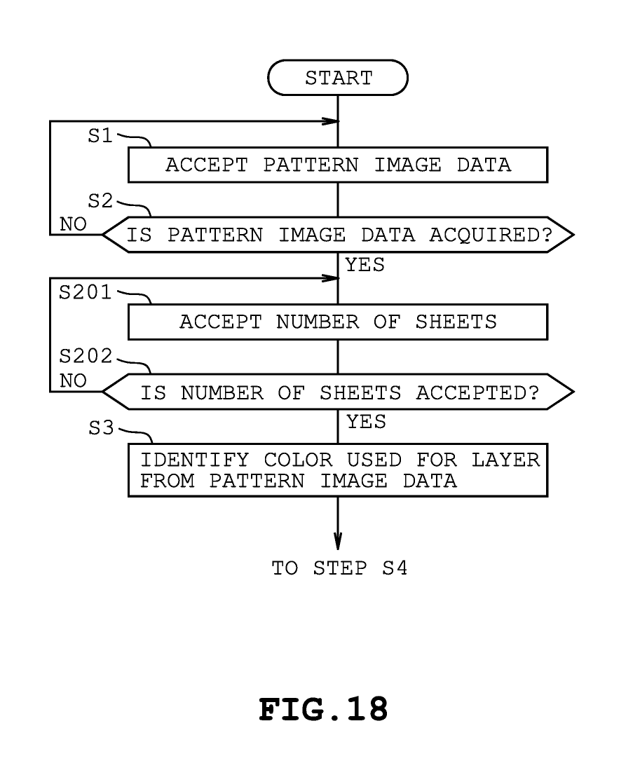

Specifically, after the control circuit 5 acquires the pattern image data in the steps S1 and S2 and before the control circuit 5 acquires the color information from the pattern image data in the step S3, the control circuit 5 causes, for example, the display 3 to display a number-of-sheets setting screen (not shown) for inputting the number of sheets 20 used for preparing the decoration (step S201 in FIG. 18). The user operates the mouse 4b or the like to input the number of sheets 20 while viewing the number-of-sheets setting screen. The control circuit 5 receives the input signal (YES in step S202) and acquires the number of sheets N_{IN} of the sheets 20. The following description is made assuming that the number of sheets N_{IN} of the sheets 20 input by the user is “4”.

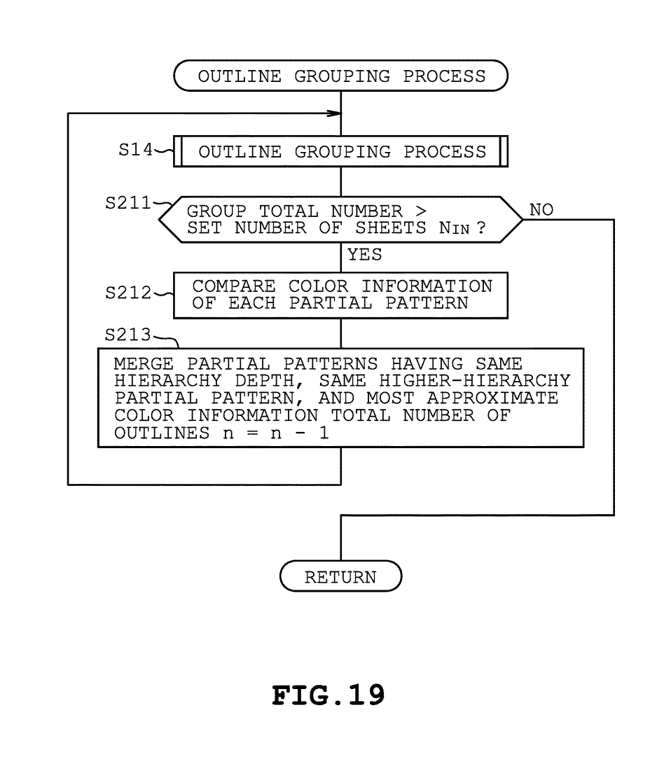

After that, in the step S3, four colors of the partial patterns H, A, . . . , and F shown in FIG. 17(a) are identified and the first mode is selected in the step S5 (YES), the process shifts to the first cutting data creation process (see FIG. 9). In the first cutting data creation process of the second exemplary embodiment, the steps S11 to S13 are executed, and then the grouping process shown in FIG. 19 is executed instead of the step S14.

In the grouping process of the second exemplary embodiment, the grouping process (step S14) of the first exemplary embodiment is first executed. Thus, the partial patterns H, A, . . . , and F corresponding to the outline total number n of 7 are grouped as Group₍₀₎ to Group₍₀₎ with the group total number N of 5 (see FIG. 6(b)). In this case, when the control circuit 5 determines that the group total number N is greater than the number of sheets N_{IN} of the sheets 20 set in the step S202 (YES in step S211), the control circuit 5 compares the color information linked to the Group₍₀₎ to Group₍₀₎ (or partial patterns) (step S212).

Further, the control circuit 5 specifies the partial patterns for which the outline total number n is reduced by 1, based on the compared color information for the Group₍₀₎ to Group₍₄₎, the hierarchy depth obtained from the inclusion relation of the partial patterns, and whether or not outlines in higher hierarchies have the partial pattern (step S213). Specifically, in the partial patterns having the same hierarchy depth, for example, the partial patterns A and F with the hierarchy depth of “1” (see h₍₁₎ and h₍₆₎ in FIG. 17(a)), the control circuit 5 performs a process for reducing the number of colors from two colors of the partial patterns whose values, such as grayscale values or RGB values, which are color information, are most approximate to each other, to one color. Thus, green of the partial pattern F shown in FIG. 17(a) is merged as black of the partial pattern A, and the color used for the layer 50 is updated with three colors, i.e., yellow-green, black, and yellow. Further, the control circuit 5 combines the partial patterns A and F and sets a new Outline₍₁₎ of the partial pattern G corresponding to the extraction number “i” of 1, thereby grouping the partial patterns. Along with this operation, the control circuit 5 decrements the value of the outline total number n by 1 (n=n−1), and executes step S14 again, thereby assigning a new group number to each of the four groups of Group₍₀₎ to Group₍₃₎ shown in FIG. 17(b).

Thus, when the control circuit 5 executes steps S14 and S211 to S213 and determines that the group total number N is “4” which is equal to the set number of sheets N_{IN} of the sheets 20 (NO in step S211), the control circuit 5 returns to the step S15. The grouping step (steps S14 and S211 to S213) of the second exemplary embodiment may be executed in the second cutting data creation process, instead of the process of the step S103. Consequently, the first and second cutting data with which the decorations 51 and 52 can be obtained can be created by using the user's desired number of sheets 20 or by further reducing the number of sheets 20.

As described above, the cutting data creation method according to the second exemplary embodiment includes a number-of-sheets setting step (steps S201 and S202; a number-of-layers setting unit) of setting the number N_{IN} of the sheets 20 (layers 50). The grouping step includes specifying the partial patterns to be grouped from the plurality of partial patterns based on the set number N_{IN} of the sheets 20, the color information about the partial patterns, and the result of the discrimination as to whether one of a plurality of partial patterns is included in another one of the plurality of partial patterns. The control circuit 5, the display 3, and the input unit 4 are configured as a number-of-layers setting unit that sets the number N_{IN} of the layers corresponding to the number N_{IN} of the sheet 20.

With this configuration, based on the number N_{IN} of the sheets 20 (layers 50) set in the number-of-sheets setting step (layer number setting unit), the color information about the partial patterns, and the result of the discrimination as to whether one of a plurality of partial patterns is included in another one of the plurality of partial patterns, for example, the plurality of partial patterns, such as the partial patterns A and F and the partial patterns C to E, can be grouped as one group. Further, when the plurality of partial patterns is grouped as one group, the corresponding order of the sheets 20 is allocated for each group, so that the number of sheets used as the sheets 20 necessary for preparing the decorations 51 and 52 can be reduced according to the set number N_{IN} of the sheets 20.

The disclosure is not limited only to the exemplary embodiments described above, but may be modified or expanded as follows. The cutting data creation device may have a configuration in which a so-called dedicated device or the cutting device 11 has the cutting data creation function.

The recording medium storing the cutting data creation program is not limited to the EEPROM 8 and the like, but instead may be various recording media such as a USB memory, a CD-ROM, a flexible disk, a DVD, and a memory card. In this case, the operation and effects similar to those of the above exemplary embodiments can be obtained by loading a program stored in the recording medium into a computer of various data processing devices and causing the computer to execute the loaded program.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

What is claimed is:

1. A cutting data creation method for creating cutting data for preparing a decoration representing an entire pattern formed of a combination of a plurality of partial patterns by superimposing a plurality of sheets cut along an outline of each of the plurality of partial patterns, the cutting data creation method comprising:
a discrimination step of discriminating, for each partial pattern, whether or not one of the plurality of partial patterns is included in another one of the plurality of partial patterns;
an order decision step of deciding an overlapping order of the plurality of partial patterns corresponding to an overlapping order of the plurality of sheets based on a result of the discrimination as to whether or not one of the plurality of partial patterns is included in another one of the plurality of partial patterns in the discrimination step;
an outline setting step of setting an outline of each of the partial patterns for each of the sheets corresponding to the order decided in the order decision step; and
a cutting data creation step of creating cutting data based on the outline of each of the partial patterns set for each of the sheets in the outline setting step.

2. The cutting data creation method according to claim 1, further comprising:
a color information acquisition step of acquiring color information about the plurality of partial patterns for each of the partial patterns; and
a grouping step of grouping, as one group, specific partial patterns from the plurality of partial patterns based on the color information about the partial patterns acquired in the color information acquisition step and the result of the discrimination as to whether or not one of the plurality of partial patterns is included in another one of the plurality of partial patterns in the discrimination step,
wherein the order decision step includes allocating an order for each group to the specific partial patterns belonging to the group among the plurality of partial patterns, and allocating an order for each of partial patterns to the partial patterns other than the specific partial patterns.

3. The cutting data creation method according to claim 2, further comprising a number-of-sheets setting step of setting the number of the sheets, wherein
the grouping step includes specifying partial patterns to be grouped from the plurality of partial patterns based on the number of sheets set in the number-of-sheets setting step, the color information about the partial patterns acquired in the color information acquisition step, and the result of the discrimination as to whether or not one of the plurality of partial patterns is included in another one of the plurality of partial patterns in the discrimination step.

4. The cutting data creation method according to claim 1, further comprising a selection step of selecting one of:
a first mode in which the partial patterns are concave backward and the entire pattern has a concave shape with respect to a top sheet when the plurality of sheets is superimposed; and
a second mode in which the partial patterns are convex forward and the entire pattern has a convex shape with respect to a bottom sheet when the plurality of sheets is superimposed.

5. The cutting data creation method according to claim 4, wherein the order decision step includes deciding an overlapping order of the plurality of partial patterns according to the mode selected in the selection step.

6. The cutting data creation method according to claim 2, further comprising:
a display step of displaying, on a display, specific partial patterns grouped in the grouping step; and
an accepting step of accepting an input to determine whether the grouped specific partial patterns displayed on the display in the display step are defective or non-defective.

7. A cutting data creation device for creating cutting data for preparing a decoration representing an entire pattern formed of a combination of a plurality of partial patterns by superimposing a plurality of sheets cut along an outline of each of the plurality of partial patterns, the cutting data creation device comprising:
a discrimination unit configured to discriminate, for each partial pattern, whether or not one of the plurality of partial patterns is included in another one of the plurality of partial patterns;
an order decision unit configured to decide an overlapping order of the plurality of partial patterns corresponding to an overlapping order of the plurality of sheets based on a result of the discrimination as to whether or not one of the plurality of partial patterns is included in another one of the plurality of partial patterns by the discrimination unit;
an outline setting unit configured to set, for each layer corresponding to the order decided by the order decision unit, an outline of each of the partial patterns to a plurality of layers respectively corresponding to the plurality of sheets; and
a cutting data creation unit configured to create cutting data corresponding to the plurality of sheets based on the outline of each of the partial patterns set for each of the layers by the outline setting unit.

8. The cutting data creation device according to claim 7, further comprising:
a color information acquisition unit configured to acquire, for each of the partial patterns, color information about the plurality of partial patterns; and
a grouping unit configured to group, as one group, specific partial patterns from the plurality of partial patterns based on the color information about the partial patterns acquired by the color information acquisition unit and the result of the discrimination as to whether or not one of the plurality of partial patterns is included in another one of the plurality of partial patterns by the discrimination unit,
wherein the order decision unit allocates an order for each group to the specific partial patterns belonging to the group among the plurality of partial patterns, and allocates an order for each of partial patterns to the partial patterns other than the specific partial patterns.

9. The cutting data creation device according to claim 8, further comprising a number-of-layers setting unit configured to set the number of the layers,
wherein the grouping unit specifies partial patterns to be grouped from the plurality of partial patterns based on the number of layers set by the number-of-layers setting unit, the color information about the partial patterns acquired by the color information acquisition unit, and the result of the discrimination as to whether or not one of the plurality of partial patterns is included in another one of the plurality of partial patterns by the discrimination unit.

10. The cutting data creation device according to claim 7, further comprising a selection unit configured to select one of:
a first mode in which an internal part of each of the partial patterns is represented by a lower layer and the entire pattern has a concave shape with respect to a top layer when the plurality of layers is superimposed; and
a second mode in which each of the partial patterns are represented by an upper layer and the entire pattern has a convex shape with respect to a bottom layer when the plurality of layers is superimposed.

11. The cutting data creation device according to claim 10, wherein the order decision unit decides an overlapping order of the plurality of partial patterns according to the mode selected by the selection unit.

12. The cutting data creation device according to claim 8 further comprising:
a display;
a display unit configured to display, on the display, specific partial patterns grouped by the grouping unit; and
an accepting unit configured to accept an input to determine whether the grouped specific partial patterns displayed on the display by the display unit are defective or non-defective.

13. A computer-readable recording medium recording a program for causing a computer to function as various processing units of the cutting data creation device according to claim 7.
